(19) United States
(12) Patent Application Publication
(10) Pub. No.: US 2014/0278882 A1
(43) Pub. Date: Sep. 18, 2014

(54) METHOD AND SYSTEM FOR IMPLEMENTING ELECTRONIC PROMOTIONAL OFFERS

(71) Applicant: CHEER BERRY LIMITED, Hong Kong (CN)

(72) Inventors: Wing Fung Yu, Hong Kong (CN); Jason Felix Tsz-Kiu CHIU, Hong Kong (CN)

(73) Assignee: CHEER BERRY LIMITED, Hong Kong (CN)

(21) Appl. No.: 14/290,868

(22) Filed: May 29, 2014

Related U.S. Application Data
(63) Continuation-in-part of application No. 14/030,703, filed on Sep. 18, 2013.

(30) Foreign Application Priority Data
Sep. 18, 2012 (CN) CN201210347800.1
May 29, 2013 (CN) CN201310206463.9

(51) Int. Cl. G06Q 30/02

(52) U.S. Cl. CPC G06Q 30/0225
USPC 705/14.26

(57) ABSTRACT

A method for implementing electronic promotional offers and a promotion system are provided. In an embodiment, the method includes receiving promotional offer information associated with a consumer. Optionally the information may be transmitted by a near-field communication and/or in another form of two-way communication mode. The promotional offer information is authenticated. In one embodiment, the promotional offer information is encrypted during transmission and decrypted upon receipt. A request to confirm that the consumer wishes to redeem the promotional offer may be sent. After receiving the confirmation, the promotional offer information is processed and the promotion of the promotional offer is implemented.

### CROSS-REFERENCE TO RELATED APPLICATIONS

This application claims priority benefit of Chinese Patent Application Number CN201310206463.9 (Docket # BL-1-8), entitled “METHOD AND SYSTEM FOR IMPLEMENTING ELECTRONIC PROMOTIONAL OFFERS,” filed on May 29, 2013, by Yu Wing Fung and Jason Felix Tsz-Kiu Chiu; this application is also a continuation-in-part of U.S. patent application Ser. No. 14/030,703 (Docket # BL-1-5), entitled, “STAMP ISSUING METHOD AND STAMP ISSUING SYSTEM,” filed Sep. 18, 2013, by Wing Fung Yu and Jason Felix Tsz-Kiu Chiu, which in turn claims priority to Chinese Patent Application Number CN201210347800.1, filed Sep. 18, 2012, by Wing Fung Yu and Jason Felix Tsz-Kiu Chiu. All of the above applications are incorporated herein by reference.

### FIELD

The present specification relates to electronic promotional offers.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Electronic coupons are paperless electronic documents that are sent for free via Short Message Service (SMS), Multimedia Messaging Service (MMS), Wepull (a Chinese cross-platform Instant Messaging software), or other electronic services. Electronic coupons could be stored on mobile terminals in forms of multimedia data, such as videos, pictures and texts, and can be obtained by subscribing to electronic services, such as Wepull, net surfing, SMS and MMS, or by downloading the coupon from a single node, such as a web-server. Electronic coupons are easy to carry, quick and convenient. Electronic coupons may have similar and sometimes the same functions as traditional paper coupons. With electronic coupons, one can receive and enjoy the promotions and discounts offered by merchants or retailers. Electronic coupons, as a brand-new form of electronic data, may be used as a replacement for paper coupons.

Currently, electronic coupons can only be printed out or directly displayed on mobile terminals, or can be displayed as two-dimensional (2D) or three-dimensional (3D) bar codes. Such one-way use of electronic coupons may cause problems.

For example, electronic coupons may be shown directly to the assistant in the stores without being necessary to print out the coupons. However, when electronic coupons are not printed out, statistical data may not be accurately quantified. In the case that an electronic coupon is displayed to a store assistant without being printed out, a lot of data may not be properly recorded and ultimately lost. For example, the company that offered the coupon and the date of visit of the consumer may not be recorded and subsequently forgotten. Furthermore, because the electronic coupons are not printed and collected by the store, errors may occur in the daily or monthly statistical analysis of promotional products sold in a store, because there is no hard copy of the electronic coupons.

Also, when coupons are not printed, there are more opportunities for the store assistant to cheat. For example, a store assistant might have sold an item at a regular price but lied to the company owning the store and said that the item was sold at a discounted price based on a coupon that was not shown or does not exist, in order to collect a personal profit.

Another problem is as follows. When coupons are not printed, it is possible that some consumers may cheat and deceive the store assistants with fake coupons displayed on the mobile terminal or using fraudulent programs on the mobile terminal. For example, when a merchant or store offers and/or accepts cash vouchers, a swindler may cheat using fake electronic cash vouchers displayed on the mobile terminal or using fraudulent programs that may create and/or display fake coupons on the mobile terminal to deceive shop assistants or other consumers.

Further, when coupons need to be printed out, it may be inconvenient for consumers to print coupons using a printer terminal before going out shopping.

Yet another problems is that when coupons are displayed in forms of 2D bar codes and need to be read by a bar code reader, although information can be read and collected, the cost is high, because every retail store needs to have or rent equipment for reading bar codes and may also have to pay for the authentication for each reading.

As can be seen from the above, the current techniques have inconveniencies and deficiencies in practical applications, and it may be desirable to make an improvement.

### SUMMARY

In view of the above deficiencies, in an embodiment a method and a system are provided for implementing electronic promotional offers, in which a mobile terminal and a promotional offers terminal are in near-field communication and/or in another form of two-way communications. The implementation system not only makes electronic promotional offers redemption very convenient and safe, but also enhances the user experience and reduces the cost. Furthermore, the electronic promotional offers or other promotional offers are able to carry more information, and a plurality of types of promotional offers could be used with the promotional offers implementation system. Throughout this specification, the terms “promotional offer,” “coupon,” “stamp,” and “reward” may be substituted one for the other to obtain different embodiments.

In at least one embodiment, a method of implementing a promotion system is provided, which includes at least the following steps. A mobile terminal communicates with a promotional offers terminal, via near-field communication, or via audio frequencies as a carrier of the signals carrying the communication. The mobile terminal sends promotional offer information to the promotional offers terminal, and the promotional offers terminal authenticates and/or identifies the promotional offer information. Optionally, the promotional offers terminal sends the promotional offer information to a server for authentication and/or identification. After a successful authentication and/or identification, the promotional offers terminal sends a user confirmation request to the mobile terminal to confirm that the consumer intends to exercise the promotional offer. In this specification, the request sent to the consumer to confirm that the user intended to exercise the promotional offer may be referred to as the “user confirmation request.” In an embodiment, only after receiving the user's confirmation from the mobile terminal, will the promotional offers terminal process the promotional offer information. Optionally, the promotional offers terminal sends the promotional offer information to a retail terminal for the processing of the promotional offer information. In at least one embodiment, the mobile terminal encrypts the promotional offer information before sending the promotional offer information to the promotional offers terminal. The promotional offers terminal decrypts the promotional offer information or sends the encrypted promotional offer information to a server for decryption. In at least one embodiment, the server extracts personal data associated with the promotional offers terminal or the consumer's social network accounts and analyzes the consumer's consumption pattern and builds a consumption model. Then, the server or the promotional offers terminal pushes advertisements to the mobile terminal based on the analysis (e.g., based on the consumption model). In yet another embodiment, the mobile terminal converts different forms of promotional offers into the promotional offer information and/or other types of promotional offers according to predetermined conversion rules, e.g., the mobile terminal converts stored stamps into a particular format, e.g., coupons for sending the promotional information (e.g., rather than sending an image of the stamp), or another type of promotional offer, before sending the promotional offer information. For example, consumer may collect stamps and different promotional offers may require different numbers of stamps. In at least one embodiment of the present specification, the mobile terminal and the promotional offers terminal are in near-field communication and/or in another form of two-way communication during the transmission of the promotional offer information. Using near-field communication is convenient, and a relatively safe way of using electronic promotional offers, because near filed communication reduces the risk of the information being intercepted by an unauthorized eavesdropper, and near-field communication is also easy to implement.

At least one embodiment of the specification provides an electronic promotional offers implementation system, which includes at least a mobile terminal that is adapted to store promotional offer information and send the promotional offer information to at least a promotional offers terminal. In at least one embodiment, the mobile terminal is in near field communication with the promotional offers terminal, optionally via audio signals. The mobile terminal is associated with a user account, and/or the consumer's social network accounts. The promotional offers terminal is adapted to receive and authenticate the promotional offer information and send a user confirmation request to the mobile terminal. After receiving the user confirmation from the mobile terminal, the promotional offers terminal is adapted to process the promotional offer information. The promotion system may also include at least a server, which communicates with the promotional offers terminal and the mobile terminal. The server may authenticate and/or identify the promotional offer information received from the promotional offers terminal, extract personal data from the user account, analyze consumption data, and/or push advertisements to the mobile terminal. In at least one embodiment, the mobile terminal may encrypt the promotional offer information, and the promotional offers terminal and/or the server may decrypt the promotional offer information. In yet another embodiment, the mobile terminal converts the promotional offers according to predetermined conversion rules. For example, if the mobile terminal determines that the user has enough stamps for a particular promotional offer (e.g., a coupon), the mobile terminal can convert the stored stamps into a promotional offer. The user may choose the promotional offer that the stamps are redeemed for. In an embodiment, the mobile terminal may automatically convert the stamps into a coupon, for example, according to selections made by the user at an earlier date.

At least one embodiment of the present specification includes a low-cost promotional offers platform that can be shared by a plurality of small-sized and medium-sized stores by creating a low-cost consumer promotional offer platform that may be shared by a plurality of stores and in which a variety of promotional offers are stored in the same mobile terminal. In an embodiment, the promotion system is able to analyze the promotional offers data, which greatly enhances the competitive strength of the stores. Throughout this specification the terms “data” and “information” are used interchangeably, and may be substituted one for the other to obtain different embodiments. In an embodiment, a single mobile terminal can store various types of promotional offers, which can be used in a plurality of stores, and the mobile terminal communicates with the promotional offers platform, via at least one promotional offers terminal. In at least one embodiment, promotional offers stored in the mobile terminal are pre-stored before the current transaction. For example, a consumer made a purchase yesterday and earned some stamps, while in a transaction that the consumer wants to make today, the stamps earned yesterday are regarded as pre-stored stamps and can be used for redemption today. Throughout this specification the terms “store” and “pre-store” are used interchangeably, and may be substituted one for the other, when the substitution makes sense, to obtain different embodiments. Throughout this specification the terms “user,” “customer,” and “consumer” are used interchangeably, and may be substituted one for the other to obtain different embodiments.

In at least one embodiment, the promotion system analyzes the consumer-oriented consumption characteristics or preferences based on consumption data. Based on the consumption data analysis, one embodiment of the promotion system can provide the consumers with more effective and attractive commercial advertisements that are consumer-targeted and conforms to the consumers' preferences, consumption model, habits, or needs, while greatly enhancing the effectiveness of commercial advertisements.

Any of the above embodiments may be used alone or together with one another in any combination. Inventions encompassed within this specification may also include embodiments that are only partially mentioned or alluded to or are not mentioned or alluded to at all in this brief summary or in the abstract.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1A is a block diagram of a structure of a promotion system according to at least one embodiment;

FIG. 1B shows a block diagram of an embodiment of the system of FIG. 1A;

FIG. 2A shows a block diagram of another embodiment of the promotion system;

FIG. 2B shows a block diagram of an embodiment of the mobile terminal of FIG. 2A;

FIG. 2C shows a block diagram of an embodiment of the promotional offers terminal of FIG. 2A;

FIG. 2D shows a block diagram of an embodiment of the server of FIG. 2A;

FIG. 2E shows a block diagram of an embodiment of the retail terminal of FIG. 2A;

FIGS. 3A and 3B are flowcharts of an embodiment of a method of implementing an electronic promotional offer;

FIGS. 4A and 4B are flowcharts of an embodiment of a method of implementing stamps and/or electronic promotional offers;

FIGS. 5A and 5B are flowcharts of an embodiment of a method of encryption and decryption of promotional offer information;

FIGS. 6A and 6B are flowcharts of an embodiment of a method of authenticating a promotional offer according to time difference;

FIGS. 7A and 7B are flowcharts of an embodiment of a method of authenticating a promotional offer according to distance;

FIGS. 8A and 8B are flowcharts of an embodiment of a method of pushing advertisements;

FIGS. 9A and 9B are flowcharts of an embodiment of a method of operating the retail terminal or promotional offers terminal for implementing the promotion system;

FIG. 10 shows a block diagram of an embodiment of a computer system that may be used as the retail terminal and/or the server used in the promotion system;

FIG. 11 shows a block diagram of an embodiment of the promotional offers terminal used in the promotion system; and

FIG. 12 shows a block diagram of an embodiment of the mobile terminal used in the promotion system.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

It should be understood that specific embodiments described herein are only used to explain at least one embodiment but not used to limit the present invention.

FIG. 1A illustrates a block diagram of an embodiment of structure of a promotion system 100a. Promotion system 100a includes at least a mobile terminal 110a, which includes an information transmission module 111 and a confirmation module 112. The promotion system 100a also includes at least a promotional offers terminal 120a, which includes a first authentication module 121, a confirmation request module 122, and a promotion processing module 123. The promotion system 100a further includes at least a server 130a, which includes a second authentication module 131. In other embodiments, system 100a may not have all of the elements or features listed and/or may have other elements or features instead of, or in addition to, those listed.

Promotion system 100a sends promotional offers to consumers and provides, among other things, a system for retailers, and consumers to manage, track, and validate promotional offers and provides a system for consumers to redeem promotional offers. In at least one embodiment, the promotional offers include, but are not limited to, coupons, promotional offering stamps, discount promotional offers, promotion memberships, purchase credits, promotional offer points, mileages, promotional offer incentives, coupon promotions, cash vouchers, and/or gift tokens, for example. Throughout this specification, the terms “electronic promotional offer,” “promotional offer information” and “promotional offer” are used interchangeably, and may be substituted one for the other to obtain different embodiments. In at least one embodiment, the mobile terminal 110a encrypts the promotional offer information before sending the promotional offer information to a promotional offers terminal.

In at least one embodiment promotion system 100a implements a method of using (e.g., redeeming) promotional offers via a two-way communication mode.

Mobile terminal 110a is a mobile device used and/or owned by a consumer for receiving, storing, tracking, managing and/or redeeming promotional offers. Mobile terminal 110a may also have other uses, such as making phone calls, browsing a network, personal computing, and/or receiving messages. For example, the mobile terminal 110a may include smart phones, PDA (Personal Digital Assistant), tablet PCs, laptops, and/or other electronic mobile devices. In at least one embodiment, the mobile terminal 110a includes Apple iPhone, Apple iPod Touch, Apple iPad, Android phones, Android tablet PCs, RIM BlackBerry, Windows Phone, Nokia S60, and/or other mobile devices capable of running mobile applications. In at least one embodiment, the mobile terminal 110a includes wearable electronics or wearable devices such as Google Glass, Apple iWatch, clothing or accessories that incorporate electronic technologies and can run applications, etc. In at least one embodiment, the mobile terminal 110a is equipped with a communication module (e.g., a network interface) to communicate with a mobile communication network.

In at least one embodiment, the mobile terminal 110a stores promotional offer information regarding promotional offers associated with a consumer in a memory on mobile terminal 110 and/or in a user account, which may be stored in a memory system and/or server associated with the mobile service provider and/or a server that manages system 100a. In at least one embodiment, the mobile terminal 110a may convert different forms of promotional offers to other forms of promotional offers according to predetermined conversion rules and/or restrictions. For example, the mobile terminal 110a may receive a stamp or a coupon and convert the stamp or coupon into a particular format that the promotional offers terminal is expecting to receive.

In at least one embodiment, the mobile terminal 110a communicates with at least one promotional offers terminal and at least one server. The promotion system 100a also includes at least a program running on the server and/or the promotional offers terminal for implementing the promotion system, and at least an application running on the mobile terminal 110a for implementing the promotion system 100a. The application on mobile terminal 110a may have the following functions:

1) The application in the mobile terminal 110a may count and track the stamps, coupons, or other promotional offers accumulated by the user account associated with the mobile terminal 110a, and may show the consumer's available and redeemable promotional offers that could be obtained by converting the available stamps (or other promotional offers) into a format that the promotional offers terminal expects to receive according to the consumer's choice. When a consumer collects enough stamps, e.g., 200 stamps, he/she can choose to convert a number of stamps into a promotional offer.

2) The application allows the mobile terminal 110a to communicate with a promotional offers terminal located at a store or close to a store, and send promotional offer information to the promotional offers terminal. After successful authentication and decryption of the promotional offer information, the promotional offers terminal will initiate a communication session with the mobile terminal 110a to confirm whether the consumer wants to redeem the authenticated promotional offer.

3) The application displays the available promotional offers and allows the consumer to choose whether to redeem the promotional offers after receiving a request from the promotional offers terminal. In an embodiment, for security, only after the consumer confirms the redemption of the promotional offer (e.g., by pressing an “OK” button), will the application on mobile terminal 110a transmit the confirmation to the promotional offers terminal for processing and redemption. The redeemed promotional offer will also be deducted from a record of the user account. If the consumer discovers any problem or decides not to redeem the promotional offer, he/she can press the “Cancel” button to terminate the session.

4) After the promotional offer has been deducted from the record of the user account on the mobile terminal 110a, both the mobile terminal 110a and the promotional offers terminal display and store the redemption information of the promotional offer and update the promotional offer information in the record of the user account on the mobile terminal 110a, promotional offers terminal, and/or the server. The promotional offer information may include, but is not limited to, the number of the promotional offers redeemed (e.g., the number of stamps redeemed), the promotional offer name, and the numbers of available promotional offers after deduction.

In at least one embodiment, the promotional offers information may be encoded into 2D or 3D bar code information or other patterns or electronic data formats. In at least one embodiment, the promotional offer information is stored in a database of the mobile terminal 110a. In other embodiments, the promotional offer information is stored in databases at a promotional offers terminal and/or a server in addition to or instead of storing the promotional offer information in a database of mobile terminal 110a.

The promotional offer information may include a terminal account identifier, which may include a unique account number corresponding to the mobile terminal 110a. In at least one embodiment, the promotional offer information is linked to the account corresponding to the mobile terminal 110a. In at least one embodiment, the terminal account identifier of the mobile terminal is an International Mobile Equipment Identity (IMEI) of the mobile terminal 110a, an International Mobile Subscriber Identity (IMSI), a registered user account identifier on the mobile terminal 110a, and/or a social network account identifier registered by the mobile terminal 110a, for example. A user can login to the user account to access and manage his/her promotional offer information and/or consumption information. At least one embodiment of the promotion system 100a provides an interface for users to register or create new user accounts by themselves (e.g., via mobile terminal 110a). In this embodiment, the registered user accounts are not related to the user's social network accounts. Another embodiment allows the user to login to the user account using the login information for existing social network accounts of the user. In yet another embodiment, the user can, after creating a user account on the mobile terminal 110a, link the user account to other accounts, such as the user's email accounts and/or social network accounts. In another embodiment, when a user does not provide personal data or login information, the promotion system 100a automatically chooses the IMEI of the mobile terminal 110a as the account number of the mobile terminal 110a. In at least one embodiment, the promotional offer information such as information about the stored stamps and promotional offers of every consumer is stored on the server. In another embodiment, the promotional offer information associated with a consumer is stored in the mobile terminal account of the linked mobile terminal 110a. One embodiment of the promotion system 100a can extract personal data from the terminal account and/or selected social network accounts of the consumer. The social networks include, but are not limited to, Facebook, Twitter, Weibo (the Chinese equivalent of twitter), Renren (the Chinese equivalent of Facebook), Instagram, Whatsapp, etc. The personal data extracted may include, but is not limited to, personal preferences, habits, searching history, posts, clicked advertisements, and social circles. One embodiment of the promotion system 100a can analyze the consumption preference or model of the consumer based on the extracted personal data.

The promotional offer information may include a promotional offer number, which is a unique number that is generated to identify each promotional offer in promotion system 100a, to prevent the repeated use, fraud, or misuse of the promotional offer. In at least one embodiment, the promotional offer number includes a sequence of numerical numbers. In another embodiment, the information of each promotional offer includes a serial number. Optionally, the promotional offer numbers are generated in a batch by the server. In another embodiment, the promotional offer number includes alphabetical letters. In another embodiment, the promotional offer number is represented by bar codes. In yet another embodiment, the promotional offer number includes a mixture of letters and/or patterns. Promotional offer numbers prevent fraud or repeated redemption of the same promotional offer, or prevent multiple machines from receiving and/or processing the same promotional offer information.

The promotional offer information may include a validity start time for the promotional offer, which is a time from when a promotional offer begins to be valid.

The promotional offer information may include an expiration time for the promotional offer, which is a time when a promotional offer becomes invalid.

The promotional offer information may include a time of sending the promotional offer, which is the time when the mobile terminal 110a sends promotional offer information to the promotional offers terminal.

The promotional offer information may include a promotional offer code, which is a code that denotes the type of the promotional offer. The types of promotional offer may include, but are not limited to, discount codes, coupons that are exchanged for cash, vouchers, coupons that are exchanged for free merchandise or for discounts on merchandise, coupons that are exchanged for free or discounted services, vouchers, for example.

The promotional offer information may include rules and restrictions, which are the rules and/or restrictions that apply to the promotional offer. Some examples of rules and restrictions may include, but are not limited to, the manner in which the promotional offer is taken advantage, such as whether the promotional offer is used, redeemed, converted to another form, transferred, exchanged, sold, or traded. In at least one embodiment, the mobile terminal 110a may include various types of promotional offers and the various types of promotional offers are convertible according to promotional offer's rules. In another embodiment, the promotional offers could be redeemed only once or for a limited number of times (e.g., for the first ten uses) according to the promotional offer rules and restrictions. In another embodiment, the rules and restrictions specify the types of purchases with which the promotional offer may be used. For example, the promotional offer may only apply to purchases of a predetermined variety of merchandises or services, or certain merchandise or expenses may be excluded from the promotional offer. In at least one embodiment, the rules and restrictions may specify whether the consumer is permitted to exchange, trade, or transfer the promotional offers with other consumers.

The promotional offers can be obtained by subscribing to electronic services, such as net surfing, SMS and MMS, or by single-node downloading, or can be obtained by converting stamps to promotional offers according to predetermined stamps conversion rules. Stamps, coupons or other promotional offers may be issued based on the number or amount of purchases associated with a customer. In at least one embodiment, different types of promotional offers are convertible according to predetermined conversion rules. Conversion rules determine how or when one type of promotional offer can be converted to another type of promotional offer. For example, when the consumer has collected enough stamps, he/she can convert the stamps to a desired promotional offer and then send the desired promotional offer to the promotional offers terminal for redemption or cash back, for example. In at least one embodiment, the promotional offer's conversion rule can be stored in the mobile terminal 110a. Alternatively, the promotional offer's conversion rule can be stored in the promotional offer terminal or the server.

In an embodiment, the mobile terminal 110a includes at least an information transmission module 111 and a confirmation module 112. In other embodiments, the mobile terminal 110a may not have all of the elements or features listed and/or may have other elements or features instead of, or in addition to, those listed.

Information transmission module 111 is a module that is configured to send promotional offer information to the promotional offers terminal, which optionally may be sent in a near-field communication. In this specification, the term “module” is to be understood as being generic to software, hardware modules, and combinations of software and hardware modules. In at least one embodiment, the information transmission module 111 includes hardware such as signal generator, transmitter, and/or receiver for communicating and transmitting signals. Transmission module 111 may include a microphone, and/or an antenna. The information transmission module 111 may include algorithms for sending and/or receiving data, optionally via near-field communication (e.g., via audio frequencies). In at least one embodiment, the information transmission module 111 can send the promotional offer information, consumption information, consumer information, and/or information about the mobile terminal 110a to the promotional offers terminal and/or the server. In at least one embodiment, information transmission module 111 sends encrypted data to the promotional offers terminal and/or the server.

Confirmation module 112 of the mobile terminal 110a is a module that is configured to confirm with the consumer and send user confirmation to the promotional offers terminal. After a user uses the mobile terminal 110a to send promotional offer information to the promotional offers terminal, the promotional offers terminal will, before use, request the mobile terminal 110a to send a confirmation of the use of a promotional offer to ensure that the intended use of the promotional offer is correct and desired by the consumer. The algorithms included in confirmation module 112 may include the following steps. In step 1, confirmation module 112 receives an indication that a retailer has received a request to exercise a promotional offer. For example, the retailer may request the consumer to confirm that the consumer wants to take advantage of a particular promotional offer. For example, the consumer may inform a cashier or the POS system of a retail terminal that he/she wants to redeem a promotional offer, so that the POS system may wait for the confirmation of redeeming the promotional offer instead of waiting for payment via cash or credit card. In at least one embodiment, the consumer uses the mobile terminal 110a to initiate the redemption process via the retail terminal. For example, the consumer picks up a can of soda and walks to the cashier and/or POS machine, and at the same time initiates a redemption process of a coupon for one can of soda, so that the cashier does not need to select payment method using the POS machine. In another example, after the cashier scanned a basket of goods, when the time comes to total the goods and make the payment, the consumer tells the cashier that he/she wants to redeem a promotional offer. Then the cashier initiates the redemption process via the POS system, and asks the consumer to confirm using his/her mobile device. In response in step 2, confirmation module 112 displays a request for the user to confirm that the user intends to exercise the promotional offer, which may be displayed, via a user interface on the mobile terminal 110a. For example, the user may be given a choice of whether to click on one of two icons—one icon indicating to proceed with the transaction and the other icon indicating to cancel the transaction. For example, in an embodiment, the consumer can either choose “OK” to confirm redeeming the promotional offer or choose “Cancel” to terminate the process of using the promotional offer. In step 3, the decision of the consumer is received. If the consumer chooses “Cancel,” the algorithm proceeds to step 3, which is to cancel the redemption of the promotional offer. In step 3, the confirmation transmission module 112 terminates the session. Optionally a message is sent to the promotional offers terminal to terminate the process of redeeming the promotional offers. If the consumer chooses “OK,” the method proceeds to step 4. In step 4, the confirmation module 112a sends a user confirmation to the promotional offers terminal.

Promotional offers terminal 120a is a terminal located in retail stores or close to the retail stores. Promotional offers terminal 120 may be a standalone device or part of a retail terminal, such as a cash register. In at least one embodiment, the promotional offers terminal 120a communicates with the mobile terminal 110a and/or the server for transmitting, receiving, encrypting/decrypting, storing, authenticating, identifying, processing promotional offer information and other information The promotional offers terminal 120a may include a first authentication module 121, a confirmation request module 122, and a promotion processing module 123. In at least one other embodiment, the promotional offers terminal 120a may not have all of the elements or features listed and/or may have other elements or features instead of, or in addition to, those listed.

First authentication module 121 is configured to authenticate and/or identify the promotional offer information or forward the promotional offer information to the server. In at least one embodiment, the first authentication module 121 authenticates the promotional offer information received from the mobile terminal 110a. First authentication module 121 may check the promotional offer information received against a database of information about promotional offers that were issued to determine whether the promotional offer information received correspond to promotional offers issued. The first authentication module 121 may also check a database to determine whether the information about the consumer sending the promotional module corresponds to a consumer that should have received the promotional offer corresponding to the promotional information. The first authentication module 121 may also check the promotional offer information to determine the distance from which the promotional offer information was sent and/or the time of transmission of the promotional offer information to determine if the promotional offer information was sent from a certain proximity to the promotional offers terminal 120a and/or the promotional offer information was sent within a certain time period of receiving the promotional information. If the promotional information is received from too far away or from too long ago, then the promotional information is invalid. For example, if the promotional information is supposed to be received via a near field communication, the time of transmission should not be more than a few seconds and the distance of the transmission should not be more than a few feet (depending on the type of near-field or two-way transmission).

Confirmation request module 122 is a module that is configured to send a request, after the promotional offer information is successfully authenticated and/or identified, to the mobile terminal 110a to confirm that the user decided to redeem the promotional offers. If the consumer decides to redeem the promotional offer, the consumer may use the mobile terminal 110a to send a user confirmation back to the promotional offers terminal 120a. Otherwise, the consumer can terminate the transaction that makes use of the promotional offer by canceling the confirmation process on the mobile terminal 110a. Algorithms included in confirmation request module 122 may include the following steps. In step 1, an indication is received that a user would like to take advantage of a promotional offer and send a request to the mobile terminal 110a to confirm that the user wants to use the promotional offer. In step 2, in response to sending the request for the confirmation, a confirmation message is received confirming the transaction or a cancellation message of cancellation (requesting not to use the promotional offer) from the mobile terminal 110a. In step 3, an indication may be sent to a promotion processing module, for example, indicating whether or not to process the promotional offer information, depending on whether the consumer confirmed or canceled the transaction.

Promotion processing module 123 is a module that is configured to process the promotional offer information after receiving the user confirmation from the mobile terminal 110a. Algorithms included in promotion processing module 123 may include the following steps. In step 1, the promotion processing module 123 extracts and calculates the discount information of the promotional offer, an amount balance of cash vouchers, or other promotion information. In step 2, the promotion processing module 123 extracts or receives purchasing information of the consumer associated with the mobile terminal 110a. In step 3, the promotion processing module 123 applies the discount, cash balance or other promotions to the total or part of the balance of the purchase that the consumer has made. Optionally, in step 4, the promotion processing module 123 applies other types of promotional offers, such as vouchers of free items with purchases or free services with purchases, to the purchase made by the consumer, and notify the retail terminal that such promotional offers (e.g. free items/services) needs to be redeemed in-store. In at least one embodiment, in step 5 the promotion processing module 123 sends the promotional offer information to a retail terminal for a payment operation. In at least one embodiment, promotion processing module may also update or send an indication to a retail terminal to update records related to the transaction in which the promotional offer was used, which may include recording the use the of the promotional offer, recording a change in inventory and/or a receipt of revenues.

Server 130a is a server that stores, manages, and tracks customer data, promotional offer information, retailer information and other data. In at least one embodiment, the server 130a can also decrypt, authenticate, and/or identify the promotional offer information and analyze the consumption information to determine customer preferences and/or consumption models. The server 130a may also track the promotional offer information, update the stamps or promotional offers redeemed or track new promotional offers available and/or new promotional offers offered by the merchants or stores. In at least one embodiment, the server 130a determines (e.g., reads or extracts) personal data, promotional offers data, and/or consumption data associated with a consumer or a mobile terminal 110a, analyzes the consumption model or consumption preferences, and pushes advertisements to the mobile terminal 110a.

In at least one embodiment, the server 130a records the promotional offer information of each user account in a database. In at least one embodiment, after a consumer converts a particular number of stamps for promotional offers, the number of stamps and promotional offers is updated, and a unique promotional offer number is generated by the server 130a and assigned to each promotional offer. When the consumer redeems promotional offers, the server 130a also updates the number of promotional offers. In at least one embodiment, the server 130a provides an interface to allow administrators to create, access, and/or manage a promotional offers terminal database, various types of stamps, various types of promotions, all the information about the stamps, coupons, or other promotional offers, rules for distributing stamps, rules for converting stamps into promotional offers, for example.

The server 130a includes at least a second authentication module 131. In other embodiments, the server 130a may not have all of the elements or features listed and/or may have other elements or features instead of, or in addition to, those listed.

Second authentication module 131 is a module that is configured to authenticate and/or identify the promotional offer information forwarded by the promotional offers terminal 120a after the promotional offers terminal 120a receives the promotional offer information from the mobile terminal 110a. Second authentication module 131 may perform the same function as first authentication module 121. The authentication/identification methods that may be implemented by the second authentication module 131 were discussed in conjunction with the first authentication module 121. In at least one embodiment, the second authentication module 131 sends the results of authentication and/or identification back to the promotional offers terminal 120a and/or to the mobile terminal 110a. In at least one embodiment, each of the first authentication module 121 and second authentication module 131 perform their own authentication of the promotional offer information. In at least one embodiment, one of the first authentication module 121 and second authentication module 131 performs the authentication or a part of the authentication, and the other authentication module receives the results from the authentication module that performed the authentication.

FIG. 1B illustrates a block diagram of an embodiment of the promotion system of FIG. 1A. One embodiment of the electronic promotion system 100b includes at least a mobile terminal 110b, a promotional offers terminal 120b, a server 130b, a retail terminal 140, and a network 150. In other embodiments, system 100b may not have all of the elements or features listed and/or may have other elements or features instead of, or in addition to, those listed.

The mobile terminal 110b, the promotional offers terminal 120b, and the server 130b may be embodiment of mobile terminal 110a, the promotional offers terminal 120a, and the server 130a, which were discussed in conjunction with FIG. 1A.

The retail terminal 140 is a terminal used by a retailer for conducting a transaction. In at least one embodiment, the retail terminal 140 includes at least a computer and/or a Point of Sale (POS) machine connected to the computer. The POS machine may be a smart cash register and/or other machine that performs the financial transaction. In at least one embodiment, the retail terminal 140 includes a system which may process purchases, process promotional offer information, track inventory, track sales and transactions, issue promotional offers, update promotional offers data, update sales and inventory information as transactions are performed, analyze consumption information, and/or send consumption data to the promotional offers terminal 120b, the mobile terminal 110b and/or the server 130b. In at least one embodiment, the retail terminal 140 is directly connected to the promotional offers terminal 120b, via a communications cable. Additionally or alternatively, the retail terminal 140 communicates with the promotional offers terminal 120b via a local area network and/or wide area network.

In at least one embodiment, the retail terminal 140, the mobile terminal 110b and/or the promotional offers terminal 120b has an input device (e.g., a keypad and/or a mouse) and an output device such as a display (e.g., a monitor). In at least one embodiment, the input device is configured to operate and manipulate the retail terminal 140, the mobile terminal 110b and/or the promotional offers terminal 120b, e.g., to input, delete, or edit data. In another embodiment, the output device of the retail terminal 140b, the mobile terminal 110b and/or the promotional offers terminal 120b is configured to display promotional offer information, user information, consumption information, for example. In at least one embodiment, all information, e.g., promotional offer information and consumption information, etc., is simultaneously displayed on the output device of the retail terminal 140, the mobile terminal 110b and/or the promotional offers terminal 120b. In at least one embodiment, part of the information or selected information is displayed on the output device of the retail terminal 140, the mobile terminal 110b and/or the promotional offers terminal 120b.

The network 150 may be any combination of local area networks, wide area networks (e.g., the Internet), wireless phone networks and/or ordinary phone networks. The promotional offers terminal 120b and/or the retail terminal 140 can communicate with the server 130b via network 150. Optionally, the retail terminal 140 can communicate with the mobile terminal 110b and/or the promotional offers terminal 120b via network 150. In at least one embodiment, the retail terminal 140 and the promotional offers terminal 120b is connected, via a cable or wire or a wireless connection. In at least one embodiment, the mobile terminal 110b and the promotional offers terminal 120b can communicate with each other via network 150 or a near-field communication, in a two-way communication mode. The two-way communication mode allows the mobile terminal 110b to transmit information to the promotional offers terminal 120b, and vice versa.

As indicated in FIG. 1B, mobile terminal 110b can communicate wirelessly with promotional offers terminal 120b. In at least one embodiment, mobile terminal 110b may communicate with promotional offers terminal 120b using near field communication, e.g., via audio signals. In at least one embodiment, a gamut of audio signals can be used as the carrier for information transfer, including audible frequencies and/or non-audible frequencies. The non-audible frequencies may include ultrasonic signals and/or low frequency audio signals. In at least one embodiment, an ultrasonic signal refers to an audio signal with frequency greater than 20000 Hz. In at least one embodiment, a low frequency audio signal is a signal with frequency from 16 to 25 Hz. In at least one embodiment, the frequency of the audio signals for transmitting the promotional offer information ranges between 25 to 20000 Hz. In an indoor environment with a plurality of rooms, a non-audible audio signal in a room typically can only be received within the room, and may not be received in another room or the adjacent rooms. If a non-audible audio signal is generated in the outdoor vicinity of a plurality of buildings, the audio signal may only be received in the outdoor areas among the buildings.

If audio signals with acoustic frequencies are used as the carrier for near field communication, the user will hear the sound when the signaling is in transmission. If the user hears the sound, he/she is aware that the mobile terminal 110b or the promotional offers terminal 120b is transferring data. In some embodiments, data transfer only lasts a short period of time, e.g., no more than several seconds. For example, the transfer may one last no more than 10 seconds, no more than 5 seconds, no more than 3 second, no more than 2 seconds or no more than 1 second.

In at least one embodiment, the mobile terminal 110b and/or the promotional offers terminal 120b have at least a signal generator and at least a signal receiver. For achieving near field signal transmission and enhancing the efficiency, in at least one embodiment, the signal generator and the signal receiver needs to be close to being adjacent to each other. In at least one embodiment, when communicating, as a security feature, the distance between the mobile terminal 110a and the promotional offers terminal is very short, e.g., less than 10 cm or less than 1 cm, so that it is difficult for other mobile terminals to detect the communication. In another embodiment, the intensity of the signal sent out by the generator is adjusted to such a level that a receiver cannot receive the near field signal until the receiver is close to being adjacent to the generator (e.g., within a few millimeters or within a millimeter to provide even greater security).

FIG. 2A is a block diagram of another embodiment of the promotion system 200a. The promotion system 200a in FIG. 2A includes at least a mobile terminal 210a, which includes an information transmission module 211a, a confirmation module 212a, an encryption module 213a and a conversion module 214a. The promotion system 200a also includes at least a promotional offers terminal 220a, which includes a first authentication module 221a, a confirmation request module 222a, a promotion processing module 223a, a time record module 224a, a first positioning module 225a and a code transmission module 226a. The promotion system 200a further includes at least a server 230a, which includes a second authentication module 231a, a data extraction module 232a, an analysis module 233a, an advertisement pushing module 234a, a promotional offers terminal database 235a, and a second positioning module 236a. The promotion system 200a further includes at least a retail terminal 240a. In other embodiments, system 200a may not have all of the elements or features listed and/or may have other elements or features instead of, or in addition to, those listed.

The mobile terminal 210a, the information transmission module 211a, the confirmation module 212a, the promotional offers terminal 220a, the first authentication module 221a, the confirmation request module 222a, the promotion processing module 223a, the server 230a, and the second authentication module 231a are embodiments of or perform similar functions as mobile terminal 110a, information transmission module 111, confirmation module 112, promotional offers terminal 120a, first authentication module 121, confirmation request module 122, promotion processing module 123, server 130a, and second authentication module 131, respectively, were discussed in conjunction with FIG. 1A. The retail terminal 240a is an embodiment of retail terminal 140 which was discussed in conjunction with FIG. 1B.

The mobile terminal 210a further includes an encryption module 213a and a conversion module 214a.

Encryption module 213a of the mobile terminal 210a is a module that is configured to encrypt data. In at least one embodiment, the encryption module 213a uses asymmetric encryption methods that include an encryption key that is also referred to as a public key, and a decryption key that is also referred to as a private key, which is different from the public key. The asymmetric cryptography in at least one embodiment of the specification requires two separate keys which are mathematically linked, one of which is secret (or private) and one of which is public. The public key in at least one embodiment is used to encrypt promotional information or other information, is published without compromising security; whereas the private key is not revealed to anyone not authorized to read messages or access the promotional information. Optionally, the encryption module 213a receives the public key from the promotional offers terminal 220a or the server 230a. The encrypted promotional offer information may be transmitted by the information transmission module 211a of the mobile terminal 210a to the promotional offers terminal 220a for decryption. Other embodiments of the system 200a include other methods for encryption and decryption.

In at least one embodiment, the public key for asymmetric encryption is a terminal session code, which includes a code that is an identifier for promotional offers terminal 220a (which may be referred to as a terminal code) and a random code. In at least one embodiment, the terminal code of promotional offers terminal 220a is generated and/or designated by the server 230a. In at least one embodiment, the public key includes a random code that is valid for a limited time, also called “time sensitive token,” in order to prevent cheating or fraud by preventing repetitive use of the same public key. By setting a time limit on how long the public key is valid, if the public key is intercepted by an unauthorized user, the unauthorized user is unlikely to be able to make use of the public key and even more unlikely to be able to make use of the public key more than once, if at all. In at least one embodiment, the promotional offers terminal code does not have to be unique, because the random code in the public key ensures that the key is most likely unique. In at least one embodiment, the public key and the private key for the asymmetric encryption method is generated by the promotional offers terminal 220a or the server 230a. In other embodiments, the public key could be any code.

Conversion module 214a converts one type of promotional offer to another type of promotional offer, or converts some types of promotional offers to other types of promotional offers, according to predetermined rules. For example, if the consumer wants to purchase an item that requires a certain number of stamps, conversion module 214a may convert an appropriate number of the stamps (if the user has the enough stamps) into a coupon to redeem the stamps in exchange for the item that the consumer desires in a purchase request. Algorithms included in conversion module 214 a may include the following steps. In step 1, the conversion module 214a receives a request from a consumer, optionally via a user interface, for converting one type of promotional offers (e.g., stamps) of the consumer to another type (e.g., a coupon for a particular item). In step 2, the conversion module 214a calculates the number of stamps needed to convert to a coupon following the conversion rules. In step 3, the conversion module 214a marks the number of stamps as redeemed and/or converted, and updates the stamps information in a database at the mobile terminal 210a. In step 4, the conversion module 214a generates a coupon according to the conversion rules, and updates the coupon information in the database at the mobile terminal 210a. Optionally the conversion module 214a assigns a coupon number and/or code to the coupon, and/or records other information about the coupon. For example, a consumer collects enough stamps, e.g., 200 stamps, he/she can convert the stamps to a promotional offer for purchasing a lamp (if there is a retailer offering a lamp in exchange for 200 stamps). In at least one embodiment, stamps or other promotional offers can be obtained from the retail stores for visiting the retail establishment and/or for purchasing items.

The promotional offers terminal 220a further includes a time record module 224a, a first positioning module 225a, and a code transmission module 226a.

Time record module 224a is a module configured to record and store the time of receipt of the promotional offer, which is when the promotional offer information is received by the promotional offers terminal 220a. Time record module 224a may also read or otherwise determine and record the time of transmission of the promotional offer. In at least one embodiment, the time of receipt of the promotional offer and optionally time or transmission are sent to the first authentication module 221a of the promotional offers terminal 220a or the second authentication module 231a of the server 230a, for authentication and/or identification.

First positioning module 225a is a module configured to obtain and store the present geographical position information of the mobile terminal 210a, when the promotional offers terminal 220a receives the promotional offer information sent by the mobile terminal 210a. First positioning module 225a may include and/or interact with a Global Positioning System (GPS) chip. The present geographical position information of the mobile terminal 210a may include geographical position coordinates information (e.g., longitude, latitude, and altitude). The first positioning module 225a can interact with the built-in satellite positioning chip (or other GPS hardware), and in addition or alternatively may include an indoor positioning programs and methods that match the satellite positioning. The present geographical position of the mobile terminal 210a is sent to the first authentication module 221a for authentication. In at least one embodiment, the first positioning module 225a may obtain geographical position information of the mobile terminal 210a at any time. First positioning 225a module may also determine the position of the mobile terminal 210a at the time that the request to exercise the promotional offer (e.g., redeem stamps) is received.

Code transmission module 226a is a module configured to send a code for encryption to the mobile terminal 210a. In at least one embodiment, the code transmission module 226a sends a terminal session code optionally combined with a random code as a public key (and/or another public key) to the mobile terminal 210a, for asymmetric encryption. The public key and terminal session code were discussed in conjunction with encryption module 213a.

The server 230a further includes a data extraction module 232a, an analysis module 233a, an advertisement pushing module 234a, a promotional offers terminal database 235a, and a second positioning module 236a.

Data extraction module 232a is a module that is configured to extract personal data from an account of the consumer and/or associated with the mobile terminal 210a. In at least one embodiment, the data extraction module 232a extracts data from social network accounts associated with the consumer. In some embodiments, the data extraction module 232a extracts personal data of the consumer from the selected and/or linked social network accounts, such as personal preferences, habits, searching history, posts, clicked advertisements, and social circles, which helps to analyze the consumption models or preferences of the consumer. The social networks may include, but are not limited to, Facebook, Weibo, Twitter, and Renren. In at least one embodiment, the consumption data and/or promotional offer information may be extracted from the promotional offers terminal 220a and/or the server 230a, which may include a database having the consumer's consumption data and/or promotional offer information.

Analysis module 233a is a module that analyzes the consumption data and generates an analytical statement of characterizing the consumption, based on an analysis of the promotional offer information and consumption information associated with the mobile terminal 210a and/or the social network accounts of the consumer. In at least one embodiment, the analysis module 233a generates an analytical statement at a periodic set of times, e.g. every six hours, every day, every month, every year, and/or another time period. Analysis module 233a may adjust parameters of a consumption model that characterizes the consumption pattern of a consumer. The analysis module 233a provides information for an advertisement pushing module to push advertisements to the consumers.

Advertisement pushing module 234a is a module that is configured to push advertisements to the mobile terminal 210a according to the analytical statement of consumption generated by the analysis module 233a. In an at least one embodiment, advertisement pushing module 234a is able to regularly provide consumers with effective and attractive commercial advertisements that are consumer-targeted and conforms to the consumers' preferences, consumption model, habits or needs, meanwhile greatly enhancing the effect of commercial value of the promotional offers. In at least one embodiment, the advertisement pushing module 234a can adjust and push advertisements based on consumer's most recent consumption information or preferences.

Promotional offers terminal database 235a is a database for storing information regarding all the promotional offers terminals with promotional offers terminal 220a as an example. The promotional offers terminal database 235a may store information including, but not limited to, the installation location information, the terminal codes, and/or the terminal configurations of all the promotional offers terminals. The installation location information may include coordinates data (e.g., longitude, latitude, and altitude) about the installation position of all the promotional offers terminals.

Second positioning module 236a is a module configured to obtain and store the geographical position information of the mobile terminal 210a. The methods to obtain the position information used by the second positioning module 236a are similar to or the same as first positioning module 225a, which was discussed in conjunction with first positioning module 225a.

FIG. 2B shows a block diagram of an embodiment of the mobile terminal of FIG. 2A. The mobile terminal 210b may include an information transmission module 211b, a confirmation module 212b, an encryption module 213b, and a conversion module 214b. The mobile terminal 210b further includes a user account module 215, a third positioning module 216, a fourth authentication module 217, a consumption analyzer module 218, a social network application 219.1, a search module 219.2 and a first promotion database 219.3. In other embodiments, the mobile terminal 210b may not have all of the elements or features listed and/or may have other elements or features instead of, or in addition to, those listed.

Mobile terminal 210b may include all of the functions and features discussed in conjunction with mobile terminal 110a, 110b, and 210a. Information transmission module 211a, confirmation module 212a, encryption module 213a, and conversion module 214a were discussed in conjunction with FIG. 2A.

User account module 215 is a module configured to manage a user account associated with a user and/or the mobile terminal 210b. In at least one embodiment, the user account module 215 includes algorithms allowing the consumer to create and/or register to a promotional offers account associated with the mobile terminal 210b, via a user interface. In at least one embodiment, the user could link his/her social network accounts or email accounts and login to the user account associated with the mobile terminal 210b. Mobile terminal 210b may log into on server 130a, 130b, or 230a, for example, to access the user account stored on server 130a, 130b, or 230a. In at least one embodiment, the user account module 215 may use the terminal account number or identification (ID) of the mobile terminal 210b as the user account number. Optionally, the terminal account number or ID may include an International Mobile Equipment Identity (IMEI), an International mobile Subscriber Identity (IMSI), for example. In at least one embodiment, a user does not need to provide personal data or login information, while the user account module 215 automatically chooses the IMEI or IMSI of the mobile terminal 210b as the account number of the mobile terminal 210b. In at least one embodiment, the user account module 215 allows the user to access and manage his/her user account information on the server 130a, 130b, or 230a, including, but not limited to, promotional offer information, promotional offers conversion options, available, and/or redeemed promotional offers, available and/or redeemed stamps, consumption records and/or analysis, advertisement promotional offering, promotional offers search, for example.

Third positioning module 216 is a module configured to obtain, record, and/or display the present geographical position of the mobile terminal 210b, and/or transmit the present geographical position of the mobile terminal 210 to the promotional offers terminal 222a or the server 230a. The third positioning module 216 may also obtain the geographical position of the promotional offers terminal 220a and/or the retail terminal 240a. Third positional module 216 may interface with a GPS chip or other hardware for determining the position of mobile terminal 210.

Fourth authentication module 217 is a module configured to authenticate communications from server 230a, retail terminal 240a, and/or promotional offers terminal 220a. In at least one embodiment, the fourth authentication module 217 authenticates electronic promotional offers distributed by the server 230a or retail terminal 240a.

Consumption analyzer module 218 is a module configured to analyze purchasing patterns or models of the user, based on consumption information and/or promotional offer information associated with the user account of the mobile terminal 210b or the social network accounts. Results of the analysis of the consumption data may be sent to the server.

Social network application 219.1 is an application having a user interface that allows the user to login to the social networks and/or link the social network accounts with the promotional offers account associated with the mobile terminal 210b. Optionally, the consumer can also login to the user account (which is on the server), via the social network application 219.1. In at least one embodiment, the social network application may include a link that a consumer, after logging into the social network account, could click the link which redirects the consumer to the promotional offers account. In at least one embodiment, the user could also view, display, post, and/or send promotional offers using social network application 219.1.

Search module 219.2 is a module configured to allow the consumer to search for available promotional offer information, redeemed promotional offer information, promotional offers conversion rules and restrictions, and/or promotional offers conversion options. In at least one embodiment, the consumer could use the promotional offers search module 219.2 to search for available promotional offers such as stamps or promotional offers that are stored in the mobile terminal 210b. In at least one embodiment, the consumer could use the promotional offers search module 219.2 in communication with the server 230a or promotional offers terminal 220a to search the promotional offers platform for promotional offer information offered by a plurality of retailers or merchants, and then download or use the desired promotional offers. In at least one embodiment, the consumer could search for the available promotional offers that could be obtained by converting the existing or stored promotional offers of the consumer, via promotional offers search module 219.2. For example, the consumer has earned 1000 stamps that have been stored on the mobile terminal 210b, and could use the promotional offers search module 219.2 to search for available promotional offers or promotional offers that can be obtained by converting all or a number of the 1000 stamps (such as which items the user may purchase using the stamps accumulated).

First promotion database 219.3 is a database that stores the promotional offer information on the mobile terminal 210b. The promotional offer information was discussed in conjunction with FIG. 1A. In at least one embodiment, the promotional offer information is updated in the first promotion database 219.3 after the promotional offers terminal 220a or the retail terminal 240a has processed the promotional offers, or after the consumer manipulates and/or changes the promotional offer information including, but not limited to, converting promotional offers, deleting promotional offer information, adding, receiving, and/or downloading promotional offer information, exchanging, or trading promotional offers.

FIG. 2C shows a block diagram of an embodiment of the promotional offers terminal of FIG. 2A. The promotional offers terminal 220b may include a first authentication module 221b, a confirmation request module 222b, a promotion processing module 223b, a time record module 224b, a first positioning module 225b, and a code transmission module 226b, which may include the structures and perform the functions and/or algorithms as first authentication module 221a, confirmation request module 222a, promotion processing module 223a, time record module 224a, first positioning module 225a, and code transmission module 226a, respectively, which are discussed in conjunction with FIG. 2A. The promotional offers terminal 220b further includes an encryption and decryption module 227, a communications module 228, and a second promotion database 229. In other embodiments, the promotional offers terminal 220b may not have all of the elements or features listed and/or may have other elements or features instead of, or in addition to, those listed.

Encryption and decryption module 227 is a module that is configured to encrypt and/or decrypt data. In at least one embodiment, encryption and decryption module 227 uses an asymmetric encryption method. In at least one embodiment, as discussed in conjunction with encryption module 213a or 213b, the mobile terminal 210a or 210b encrypts the promotional offer information with a public key, optionally sent by the promotional offers terminal 220b to the mobile terminal 210a or 210b. In at least one embodiment, the encryption and decryption module 227 uses a private key to decrypt the promotional offer information received from the mobile terminal 10. In at least one embodiment, the encryption and decryption module 227 uses the same public key to decrypt the promotional offer information. Optionally, the key for encryption and/or decryption could be generated and/or distributed by the promotional offers 220b or the server 230a.

Communications module 228 is a module that is configured to generate and/or receive signals. In at least one embodiment, the communications module 228 may include an electro-magnetic converting apparatus and/or a near field communication (NFC) transceiver. In at least one embodiment, the communications module 228 is adapted to generate and/or receive audio signals, convert promotional offer information, and/or consumption information into audio signals and transmit the signals to the mobile terminal 210a or 210b, as well as receive audio signals from the mobile terminal 210a or 210b. In at least one embodiment, the communications module 228 is adapted to convert the promotional offer information and consumption information into radio wave signals and send the same to a smart card chip of the mobile terminal 210a or 210b.

The communications module 228 may include a speaker or mini speaker for generating audio signals, and/or a microphone or mini microphone for receiving audio signals. Some embodiments of the communications module 228 may include a protective shell, which may attenuate audio signals, for preventing other terminals from receiving the audio signal sent out from the communications module 228. In at least one embodiment, the communications module 228 sends audio signals at a level that a microphone cannot receive the audio signal until the microphone is close to being adjacent to the promotional offers terminal 220b (e.g., within a few millimeters or within a few centimeters).

Second promotion database 229 is a database that stores the promotional offer information on the promotional offers terminal 220b. The promotional offer information (which may stored in second promotion database 229) was discussed in conjunction with FIG. 1A and the first promotion database 219.3 of FIG. 2B.

FIG. 2D shows a block diagram of an embodiment of the server of FIG. 2A. The server 230b may include a second authentication module 231b, a data extraction module 232b, an analysis module 233b, an advertisement pushing module 234b, a promotional offers terminal database 235b, and a second positioning module 236b which include the structures, functions, and algorithms of second authentication module 231a, data extraction module 232a, analysis module 233a, advertisement pushing module 234a, promotional offers terminal database 235a, and second positioning module 236a, respectively, which were discussed in conjunction with FIG. 2A. The server 230b may further include a third promotion database 237, a consumer database 238, a retailer database 239.1, a rules database 239.2, and a promotion manager 239.3. In other embodiments, the server 230b may not have all of the elements or features listed and/or may have other elements or features instead of, or in addition to, those listed.

Third promotional offers database 237 is a database that stores the promotional offer information on the server 230b. The promotional offer information was discussed in conjunction with FIG. 1A and the first promotion database 219.3 of FIG. 2B.

Consumer database 238 is a database that stores the personal data of the consumers. The consumer database 238 includes consumers' personal data including, but not limited to, customer's age, education, current employer, places visited, purchasing history, searching history, searching keywords, personal preferences, habits, posts, clicked advertisements, and social circles. In at least one embodiment, consumer database 238 receives and updates consumer's promotional offers data and consumption data, optionally including shopping receipts, time and location. In at least one embodiment, the consumer database 238 provides data for the analysis module 233b to analyze the consumer's personal preference and habits, for example.

Retailer database 239.1 is a database that stores the retailers' information. The retailer database 239.1 stores and/or updates information of a plurality of retailers including, but not limited to, retailer name, hours, store locations, contact information, websites, advertisements related to the retailer, promotion system, memberships offered, current and/or expired promotional offers, and/or promotions, for example. In at least one embodiment, the retailer database 239.1 provides information for the advertisement pushing module 234b to select and push advertisements that confirms to the consumer's preferences or consumption model. In at least one embodiment, the retailer database 239.1 provides data for a promotional offers manager to manage the promotional offer information of different retailers.

Rules database 239.2 is a database that stores the rules and/or restrictions information regarding the promotional offers. In at least one embodiment, the rules database 239.2 includes the rules and/or restrictions for the actions that include, but are not limited to, using, redeeming, converting, transferring, exchanging, purchasing, or trading the promotional offers. The rules and/or restrictions regarding the promotional offers were discussed in conjunction with FIG. 1A.

Promotion manager 239.3 is a module that is configured for an administrator to view, search, sort, adjust, update, edit, delete, extract promotional offer information. Optionally, the promotion manager 239.3 extracts and/or updates promotional offer information at the third promotion database 237, the consumer database 238, and/or the retailer database 239.1.

FIG. 2E shows a block diagram of an embodiment of the retail terminal of FIG. 2A. The retail terminal 240b may include a communications module 241, a third authentication module 242, a promotion issuing module 243, a purchase processing module 244, a promotion processing module 245, a fourth promotion database 246, a sales database 247, and a sales analyzer 248. In other embodiments, the retail terminal 240b may not have all of the elements or features listed and/or may have other elements or features instead of, or in addition to, those listed.

Communications module 241 is a module that is adapted to manage information transmission and communication with mobile terminal 210a or 210b, promotional offers terminal 220a or 220b, and/or server 230a or 230b. In at least one embodiment, the communications module 241 may include hardware such as signal generator, transmitters, receivers, and/or software for interacting with the transmitter and receiver.

Third authentication module 242 is a module configured to authenticate communications from the promotional offers terminal 220a or 220b, server 230a or 230b, and/or mobile terminal 210a or 210b. Some authentication methods that may be used in authentication module 241 were discussed with the first authentication module 121 of FIG. 1A.

Promotion issuing module 243 is a module configured to issue promotional offers based on predetermined promotional offers issuing rules and/or restrictions. For example, the promotion issuing module 243 may issue promotional offers, such as stamps, accumulated points, and/or mileage points, and promotional offers based on the number of purchases, payment amounts, and/or number of visits to the stores. The promotion issuing module 243 may directly deposit the stamps or promotional offer into the promotional offers account associate with the mobile terminal 210a or 210b, or send new promotional offer information or reminders to redeem existing promotional offers, via electronic messages or alerts. In at least one embodiment, the promotional offers issuing module 243 may send updated statement of the promotional offers of the consumer, after issuing new promotional offers, to the server 230a or 230b, mobile terminal 210a or 210b, and/or promotional offers terminal 220a or 220b. In at least one embodiment, the promotion issuing module 243 sends the statements of promotional offers at a periodic set of times, e.g. every four hours, every day, every month, every year, and/or another time period. One embodiment of the promotion issuing module 243 records and transmits the issued promotional offer information including, but not limited to, identifier (e.g. a serial number) of the issued promotional offer, a date and time that the promotional offer was issued, the amount of the purchase or purchasing receipt, and the items purchased that triggered the issuance of the promotional offer.

Purchase processing module 244 is a module configured to complete payment operations for purchases. Purchase processing module 244 may include software for tallying an order and updating information in records pertaining inventory and cash to accurately reflect the current inventory, money received, and cash on hand after the purchase. Purchase processing module 244 may compute discounts based on promotional offers being applied as part of computing the amount that the customer owes. Purchasing processing module 244 may interface with a cash register or other Point of Sale (POS) machine. In at least one embodiment, the purchase processing module 244 allows the store assistant to operate the payment process on the retail terminal 240b (purchase processing module 244 may include a computer and/or a Point of Sale (POS) machine (e.g., a cash register) connected to the computer). The consumer may pay for the balance after the promotional offers are processed and applied. Optionally, the consumer can pay, via purchase processing module 244, with credit cards, debit cards, cash, gift cards, checks, for example.

Promotion processing module 245 is a module configured to process the promotional offer information. The methods of processing the promotional offer information via promotion processing module 245 include the methods of performed by promotional processing module 123, which was discussed in conjunction with the discussion of FIG. 1A. The results of promotion processing module 245 may be used by purchase processing module 244 when computing the amount that the consumer owes for a particular purchase.

Fourth promotion database 246 is a database that stores the promotional offer information on the retail terminal 240b. The promotional offer information was discussed in conjunction with FIG. 1A and first promotion database 219.3 of FIG. 2B. In an embodiment, both first promotion database 219.3 and fourth promotion database 246, so that both retail terminal 240b and promotion offers terminal 220b have the same promotional information readily available for efficient operation and/or so that one may backup the other. In another embodiment, each first promotion database 219.3 and fourth promotion database 246 stores different promotional information and shares the promotional information with both retail terminal 240b and promotion offers terminal 220b. In yet another embodiment, only one of first promotion database 219.3 and fourth promotion database 246 are present, and both retail terminal 240b and promotion offers terminal 220b obtain the promotional information from the same database.

Sales database 247 is a database that stores and/or updates the sales data of the retail terminal 240b. The sales database 247 may track and updates sales data including, but not limited to, product sales, customer counts, revenues, promotions, for example. In an embodiment, purchase processing module 244 may update sales database 247, with each purchase and/or periodically.

Sales analyzer 248 is a module configured to analyze the sales data based on the sales information, promotional offer information, consumption information and/or inventory corresponding to the retail terminal 240b. In at least one embodiment, the sales data could be extracted from the sales database 247 of the retail terminal 240b. The sales analyzer 248 provides information for the retail stores to help manage the inventory, promotions, promotional offers programs, and/or marketing. Sales analyzer 248 may interact with analysis module 233a and/or advertisement pushing module 234a or 234b to determine whether to send an advertisement and/or promotional offer. For example, the sales analyzer 248 may indicate that stock of a particular chair is high while sales of the chair is low, and to promote the sales, promotional offers such as a discount coupon could be sent to consumers to encourage more buyers. As another example, it may be that the analysis module 233a or 233b indicate that a particular consumer is likely to want to buy a chair. In contrast, however, sales analyzer 248 may indicate that sales of chairs are high and that offering promotional offer for chairs may result in a shortage of chairs. Consequently, no promotional offer would be offered for chairs.

FIGS. 3A, 4A, 5A, 6A, 7A, 8A, and 9A are related to FIGS. 3B, 4B, 5B, 6B, 7B, 8B, and 9B in that FIGS. 3B, 4B, 5B, 6B, 7B, 8B and 9B show further details of optional embodiments of the methods of FIGS. 3A, 4A, 5A, 6A, 7A, 8A, and 9A, respectively. FIGS. 3B, 4B, 5B, 6B, 7B, 8B, and 9B also clarify which terminal performs each of the steps of FIGS. 3A, 4A, 5A, 6A, 7A, 8A and 9A, respectively. In FIGS. 3B, 4B, 5B, 6B, 7B, 8B, and 9B, the steps are placed on different lines in which each line represents the terminal that performs the indicated step. The collections of steps located on the same line are the steps performed by that terminal and represent a method implemented by that terminal.

FIGS. 3A and 3B are flowcharts of an embodiment of a method 300 of implementing a promotional offer by a promotion system described in any one of FIG. 1A, 1B, 2A-E. Mobile terminal 301 may be any of the mobile terminals 110a, 110b, 210a, and 210b. Promotional offers terminal 320 may be any of the promotional offers terminals 120a, 120b, 220a, and 220b. Server 330 may be any of the servers 130a, 130b, 230a, and 230b.

In step S301, the mobile terminal 310 sends promotional offer information to the promotional offers terminal 320. In at least one embodiment, the mobile terminal 310 sends promotional offer information that is encrypted by the mobile terminal 310. In sub-step S301a, the mobile terminal 310 sends the promotional offer information. In sub-step S301b, the promotional offers terminal 320 receives the promotional offer information.

In step S302, the promotional offers terminal 320 authenticates and/or identifies the promotional offer information received from the mobile terminal 310, or sends the promotional offer information to the server 330 for authentication and/or identification.

In sub-step S302a, the promotional offers terminal 320 authenticates/identifies the promotional offer information. In sub-step S302b, the promotional offers terminal 320 sends the promotional offer information. In sub-step S302c, the server 330 receives the promotional offer information. In sub-step S302d, the server 330 authenticates/identifies the promotional offer information. Optionally, the server 330 sends the result of the authentication/identification to the promotional offers terminal 320. In other embodiments, the authentication is performed by one of the promotional offers terminal 320 and server 330, rather than both.

In step S303, after the promotional offer information is successfully authenticated and/or identified, the promotional offers terminal 320 sends a user confirmation request to the mobile terminal 310 to confirm that the consumer decided to redeem the promotional offer. In sub-step S303a, the promotional offers terminal 320 sends a request for user confirmation. In sub-step S303b, the mobile terminal 310 receives the user confirmation request.

In step S304, the mobile terminal 310 confirms the intent to redeem the promotional offer (unless the user decides to cancel the transaction), and send user confirmation to the promotional offers terminal 320 for processing.

In sub-step S304a, the mobile terminal 310 sends the user confirmation (unless the consumer changes their mind and decides not to exercise the promotional offer). In sub-step S304b, the promotional offers terminal 320 receives the user confirmation. In sub-step S304c, promotional offers terminal 320 applies the promotional offer to a purchase or issues the rewards associated with a promotional offer. In sub-step S304c, the promotional offers terminal 320 includes the structures and performs the processes of promotion processing module 123, which was discussed in conjunction with FIG. 1A.

In an embodiment, each of the steps of method 300 is a distinct step. In at least one embodiment, although depicted as distinct steps in FIGS. 3A and 3B, step S301-S304 may not be distinct steps. In other embodiments, method 300 may not have all of the above steps and/or may have other steps in addition to or instead of those listed above. The steps of method 300 may be performed in another order. Subsets of the steps listed above as part of method 300 may be used to form their own method.

FIGS. 4A and 4B are flowcharts of an embodiment of a method 400 of implementing stamps and other promotional offers by a promotion system described in any one of FIG. 1A, 1B, and/or 2A-E. Mobile terminal 410 may be any of the mobile terminals 110a, 110b, 210a, and 210b. Promotional offers terminal 420 may be any of the promotional offers terminals 120a, 120b, 220a, and 220b. Server 430 may be any of the servers 130a, 130b, 230a, and 230b. Retail terminal 440 may be any of the retail terminals 140, 240a, and 240b.

In step S401, the mobile terminal 410 converts the stored stamps for promotional offer information according to a predetermined conversion rules into a particular form (e.g., a coupon), which may be used in a request for a purchase or a request for a redemption of another reward. The conversion of promotional offers and the conversion rules were discussed in conjunction with FIG. 1A.

Steps S402, S403, S404, S405, and sub-steps S402a, S402b, S403a, S403b, S403c, S403d, S404a, S404b, S405a, S405b, S405c of FIGS. 4A and 4B are embodiments of steps S301, S302, S303, S304, and sub-steps S301a, S301b, S302a, S302b, S302c, S302d, S303a, S303b, S304a, S304b, S304c of FIGS. 3A and 3B respectively, which are described in conjunction with FIGS. 3A and 3B.

In step S405c, after processing the promotional offer information (as described in conjunction with step 304c), the processed promotional offer information is sent to mobile terminal 410, server 430, and/or retail terminal 440.

In step S406, the promotional offer information and stamp information are updated at the mobile terminal 410 (in sub-step S406a), the promotional offer terminal 420 (in sub-step S406b), and/or the server 430 (in sub-step S406c).

In step S407, optionally, retail terminal 440 receives and process promotional offer information related to the transaction of FIGS. 4A and 4B. The mobile terminal 410, the promotional offer terminal 420 and/or server 430 may send the promotional information to retail terminal 440 prior to, as part of, or after any of the preceding steps. For example, promotional offers terminal 420 may send the promotional offer information to the retail terminal 440 for processing as part of steps S405b and/or S405c.

In step S408, the retail terminal 440 processes purchase information. Step S408 may involve implementing the processes carried out by purchase processing module 244, which were discussed in conjunction with FIG. 2E.

In step S409, the retail terminal 440 sends consumption information and/or promotional information related to the purchase to the mobile terminal (sub-step S409a) and updates the consumption information and/or promotional information in the first promotion database 219.3 of the mobile terminal 410 (sub-step S409b). The information updated in the first promotion database 219.3 may include a receipt, a consumption summary, a list of products purchased, promotional offers redeemed, the remaining promotional offers, and a history of redeemed offers. In at least one embodiment, the term “consumption information” includes at least purchase habit and purchase history of a consumer. In one embodiment of step S409, the retail terminal 440 sends itemized purchase receipt of a transaction to the mobile terminal 410. In at least one embodiment, the first promotional database 219.3 includes all the consumption information of a consumer, including products, prices, quantity purchased in one purchase transaction, and the tally of all transactions. In at least one embodiment, the consumption information may help an advertising agent or server 430 to send out advertisements and/or promotional offers to a consumer which he/she may prefer. In at least one embodiment, the first promotional database 219.3 stores a history of redemption of promotional offers by the consumer, which may provide information related to preference of the consumer regarding redemption of promotional offers. The retail terminal 440 may also send the information related to the purchase to the promotional offers terminal 420 (sub-step S409c), and update information in the second promotion database 229. The retail terminal 440 may also sends the information related to the purchase to the server 430 (sub-step S409d) and update information in the third promotion database 237.

In an embodiment, each of the steps of method 400 is a distinct step. In at least one embodiment, although depicted as distinct steps in FIGS. 4A and 4B, step S401-S409 may not be distinct steps. In other embodiments, method 400 may not have all of the above steps and/or may have other steps in addition to or instead of those listed above. The steps of method 400 may be performed in another order. Subsets of the steps listed above as part of method 400 may be used to form their own method.

FIGS. 5A and 5B are flowcharts of an embodiment of a method 500 of encryption and decryption of a promotional offer using a promotion system described in any one of FIG. 1A, 1B, 2A-E. Mobile terminal 510 may be any of the mobile terminals 110a, 110b, 210a, and 210b. Promotional offers terminal 520 may be any of the promotional offers terminals 120a, 120b, 220a, and 220b. Server 530 may be any of the servers 130a, 130b, 230a, and 230b.

In step S501, the promotional offers terminal 520 sends a public key for asymmetric encryption to the mobile terminal 510. In sub-step S501a, the promotional offers terminal 520 sends the public key to mobile terminal 510. In sub-step S501b, the mobile terminal 510 receives the public key from promotional offers terminal 520. Step S501 may also include generating a public key and/or a private key by the promotional offers terminal 520 and/or mobile terminal 510. The asymmetric encryption methods, the public key and the private key were discussed in conjunction with encryption module 213a of FIG. 2A.

In step S502, the mobile terminal 510 encrypts the promotional offer information using the public key received from the promotional offers terminal 520 (sub-step S502a), and sends the encrypted promotional offer information to the promotional offers terminal 520. In sub-step S502b, the mobile terminal 510 sends the encrypted information, while in sub-step S502c the promotional offer terminal 520 receives the encrypted promotional offer information.

In step S503, the promotional offers terminal 520 or the server 530 decrypts, authenticates, and/or identifies the encrypted promotional offer information using a predetermined private key. In sub-step S503a, the promotional offers terminal 520 decrypts the encrypted promotional offers information using a private key. In sub-step S503b, the promotional offers terminal 520 authenticates/identifies the promotional offers information. In sub-step S503c, the encrypted promotional offer information is received and decrypted by the server 530 using a private key. In sub-step S503d, the server 530 authenticates/identifies the promotional offers information. In an embodiment, the authentication of sub-step 503b and 503d are the same. In an embodiment, the authentication of sub-step 503b and 503d are different and optionally server 530 and/or promotional offers terminal 520 check to see that the results of the other's authentication prior to fully authenticating the promotional offer information. In another embodiment, only one of sub-steps 503a and 503c are preformed and/or only one of steps 503b and 503d are performed.

In an embodiment, each of the steps of method 500 is a distinct step. In at least one embodiment, although depicted as distinct steps in FIGS. 5A and 5B, step S501-S503 may not be distinct steps. In other embodiments, method 500 may not have all of the above steps and/or may have other steps in addition to or instead of those listed above. The steps of method 500 may be performed in another order. Subsets of the steps listed above as part of method 500 may be used to form their own method.

FIGS. 6A and 6B are flowcharts of an embodiment of a method 600 of authenticating a promotional offer according to time difference using a promotion system described in any one of FIG. 1A, 1B, 2A-E. Mobile terminal 610 may be any of the mobile terminals 110a, 110b, 210a, and 210b. Promotional offers terminal 620 may be any of the promotional offers terminals 120a, 120b, 220a, and 220b. Server 630 may be any of the servers 130a, 130b, 230a, and 230b.

Method 600 may be performed as part of steps S403 (FIG. 4A), S403a (FIG. 4A), and/or S403d (FIG. 4A).

In step S601, the mobile terminal 610 sends to the promotional offers terminal 620 the promotional offer information, which optionally includes the time of sending the promotional offer information by the mobile terminal 610. Step S601 and sub-step S601a, S601b were discussed in conjunction with step 301 and sub-step S301a, S301b of FIGS. 3A and 3B, respectively.

In step S602, the promotional offers terminal 620 records the time of receipt of the promotional offer when the promotional offer information is received.

In step S603, the promotional offer terminal 620 (sub-step S603a) or the server 630 (sub-step S603b) calculates and determines if the time difference between the time of receipt of the promotional offer by the promotional offers terminal 620 and the time of sending the promotional offer by the mobile terminal 610 reaches a predetermined time threshold. Specifically, in sub-step S603a, the promotional offers terminal 620 calculates a time difference between the time of receiving the promotional offer information at the promotional offers terminal and the time of sending the promotional offer information by the mobile terminal 610, and compares the time difference with a predetermined time threshold. Optionally, the promotional offers terminal 620 sends the promotional offer information, the time of sending by the mobile terminal 610 and the time of receiving by the promotional offers terminal 620 to the server 630. In at least one embodiment, instead of the promotional offers terminal 620 performing sub-step S603a, the server 630 may calculate the time difference and compare the time differences with the time threshold in sub-step S603b.

In step S604, the authentication is considered to fail and thus is rejected if the time difference between the time of receipt of the promotional offer at the promotional offers terminal 620 and the time of sending the promotional offer by the mobile terminal 610 reaches the time threshold. In sub-step S604a, if the promotional offers terminal 620 determines in sub-step S603a that the time threshold is reached, the promotional offers terminal 620 rejects the authentication. In sub-step S604b, if the server 630 determines in sub-step S603b that the time threshold is reached, the server 630 rejects the authentication. Specifically, in sub-steps S604a and S604b if the time threshold is reached, promotional offers terminal 620 and/or the server 630, respectively, take appropriate actions in response to the failure of the authentication, such as terminating any transaction related to the promotional offer information that could not be authenticated and/or sending a failure notice to mobile terminal 610. In an embodiment in which only server 630 performs the authentication, the failure message may be sent from server 630, via promotional offers terminal 620 to mobile terminal 610.

In step S605, the authentication is considered to be successful and thus is approved if the time difference between the time of receipt of the promotional offer at the promotional offers terminal 620 and the time of sending the promotional offer by the mobile terminal 610 does not reach the time threshold. In sub-step S605a, if the promotional offers terminal 620 determines in sub-step S603a that the time threshold is not reached, the promotional offers terminal 620 approves the authentication. In sub-step S605b, if the server 630 determines in sub-step S603b that the time threshold is not reached, the server 630 approves the authentication. Specifically, in sub-steps S605a and S605b if the time threshold is not reached, promotional offers terminal 620 and/or the server 630, respectively, take appropriate actions in response to the success of the authentication, such as proceeding to other authentication methods or to identify the validity of the promotional offers. Various authentication methods and identification methods were discussed in conjunction with FIG. 1A. If all required authentications are approved, the promotional offers terminal 620 may send a notice of successful authentication and/or a request for user confirmation to the mobile terminal 610. In an embodiment in which only server 630 performs the authentication, the notice of successful authentication may be sent from server 630, via promotional offers terminal 620 to mobile terminal 610.

Steps S602-S605 and steps S601b, S602 S603a, S604a and S605a may be performed by first authentication module 121, 221a, and/or 221b. Second authentication modules 131, 231a, and/or 213b may also perform steps 603b, 604b, and S605b.

In an embodiment, each of the steps of method 600 is a distinct step. In at least one embodiment, although depicted as distinct steps in FIGS. 6A and 6B, step S601-S605 may not be distinct steps. In other embodiments, method 600 may not have all of the above steps and/or may have other steps in addition to or instead of those listed above. The steps of method 600 may be performed in another order. Subsets of the steps listed above as part of method 600 may be used to form their own method.

FIGS. 7A and 7B are flowcharts of an embodiment of a method 700 of authenticating a promotional offer according to distance using a promotion system described in any one of FIG. 1A, 1B, 2A-E. Mobile terminal 710 may be any of the mobile terminals 110a, 110b, 210a, and 210b. Promotional offers terminal 720 may be any of the promotional offers terminals 120a, 120b, 220a, and 220b. Server 730 may be any of the servers 130a, 130b, 230a, and 230b.

Method 700 may be performed as part of steps S403 (FIG. 4A), S403a (FIG. 4A), and/or S403d (FIG. 4A).

In step S701, the server 730 records the installation location information of the promotional offer terminal 720. The installation location information may include geographical position coordinates (e.g., longitude, latitude, and altitude) of the promotional offers terminal 720. Step 701 need not be performed every time a promotional offer needs to be authenticated, but may be performed once for each installation of each promotional offer terminal, for example. In an alternative embodiment, the location of each terminal may be received at server 730 prior to authenticating promotional offer information send to that promotional offer terminal.

In step S702, the mobile terminal 710 sends promotional offer information to the promotional offers terminal 720 and/or server 730. In sub-step 702a, mobile terminal 710 sends the promotional offer information to promotional offers terminal 720. In sub-step 702b promotional offers terminal 720 receives the promotional offer information. In sub-step S702c, server 730 may receive the promotional offer information, optionally from the promotional offers terminal 720 and/or mobile terminal 710. Step S702 and sub-step S702a, S702b, S702c may be the same steps as step 301 and sub-step S301a, S301b, S302c, respectively, which were discussed in conjunction with FIGS. 3A and 3B.

In step S703, the promotional offers terminal 720 (sub-step S703a) and/or the server 730 (sub-step S703b) obtains the present geographical position of the mobile terminal 710 (e.g., the present geographical location of mobile terminal 710 may be sent with the promotional offer information). Step S703 may involve implementing first positioning module 225a, first positioning module 225b, second positioning module 236a, and/or second positioning module 236b. The methods of obtaining geographical position information were discussed in conjunction with the first positioning module 225a of FIG. 2A.

In step S704, the promotional offers terminal 720 (sub-step S704a) or the server 730 (sub-step S704b) determines if the distance between the present geographical position of the mobile terminal 710 and the installation location of the promotional offer terminal 720 reaches a predetermined distance threshold. In sub-step S704a, the promotional offers terminal 720 compares coordinates of the present geographical position of the mobile terminal 710 and coordinates of installation location of the promotional offers terminal 720, and calculates the distance. The promotional offers terminal 720 also decides in sub-step S704a if the distance reaches a predetermined distance threshold. In at least one embodiment, instead of the promotional offers terminal 720 performing sub-step S704a, the server 730 may calculate the distance and compare the distance with the distance threshold in sub-step S704b.

In step S705, the authentication is considered to fail and thus is rejected if the distance between the present geographical position of the mobile terminal 710 and the installation location of the promotional offer terminal 720 reaches the distance threshold. In sub-step S705a, if the promotional offers terminal 720 determines in sub-step S704a that the distance threshold is reached, the authentication is considered to fail and the promotional offers terminal 720 will reject the authentication. In sub-step S705b, if the server 730 determines in sub-step S704b that the distance threshold is reached, the authentication is considered to fail and the server 730 will reject the authentication. In sub-steps S705a and S705b if the distance threshold is reached, promotional offers terminal 720 and/or the server 730, respectively, take appropriate actions in response to the failure of the authentication. The actions in response to the failure of authentication were discussed in conjunction with sub-steps S604a and S604b of FIGS. 6A and 6B.

In step S706, the authentication is considered to be successful and thus is approved if the distance between the present geographical position of the mobile terminal 710 and the installation location of the promotional offer terminal 720 does not reach the distance threshold. In sub-step S706a, if the promotional offers terminal 720 determines in sub-step S704a that the distance threshold is not reached, the authentication is considered to be successful and the promotional offers terminal 720 will approve the authentication. In sub-step S705b, if the server 730 determines in sub-step S704b that the distance threshold is not reached, the authentication is considered to be successful and the server 730 will approve the authentication. In sub-steps S706a and S706b if the distance threshold is not reached, promotional offers terminal 720 and/or the server 730, respectively, take appropriate actions, which were discussed in conjunction with sub-steps S605a and S605b in FIGS. 6A and 6B.

Steps S703-S706 and steps S703a, S704a, S705a, and S706a may be performed by first authentication module 121, 221a, and/or 221b. Steps S703b, S704b, S705b, and S706b may be performed by second authentication modules 131, 231a, and/or 213b.

In an embodiment, each of the steps of method 700 is a distinct step. In at least one embodiment, although depicted as distinct steps in FIGS. 7A and 7B, step S701-S706 may not be distinct steps. In other embodiments, method 700 may not have all of the above steps and/or may have other steps in addition to or instead of those listed above. The steps of method 700 may be performed in another order. Subsets of the steps listed above as part of method 700 may be used to form their own method.

FIGS. 8A and 8B are flowcharts of an embodiment of a method 800 of pushing advertisements using a promotion system described in any one of FIG. 1A, 1B, 2A-E. Mobile terminal 810 may be any of the mobile terminals 110a, 110b, 210a, and 210b. Server 830 may be any of the servers 130a, 130b, 230a, and 230b.

In step S801, the server 830 extracts personal data from the social network account associated with the mobile terminal 810. In sub-step S801a, the server 830 sends a request to the mobile terminal 810 for personal data associated with a consumer and/or data associated with social network accounts of the consumer. In sub-step S801b, the mobile terminal 810 receives the request. In sub-step S801c, the mobile terminal 810 sends the personal data to the server 830. In sub-step S801d, the server 830 receives the requested personal data.

In step S802, the server 830 analyzes promotional offers information and consumption information associated with the social network accounts or the mobile terminal 810 (sub-step S802a), and generates an analytical statement of consumption (sub-step S802b). Steps 802, 802a, and 802b may be performed by analysis modules 233a or 233b. The analysis and generation of consumption statement were discussed in conjunction with the analysis module 233a of FIG. 2A, which may be invoked as part of sub-steps 802a and 802b.

In step S803, the server 830 pushes advertisements to the mobile terminal 810 according to the analytical statement of consumption. In sub-step S803a, the server 830 sends advertisements based on the statement of consumption. In sub-step S803b, the mobile terminal 810 receives the advertisements. Step S803a may be performed by pushing modules 243a or 243b. The pushing of advertisements was discussed in conjunction with the advertisement pushing module 234a of FIG. 2A, which may be implemented as part of step S803a.

In an embodiment, each of the steps of method 800 is a distinct step. In at least one embodiment, although depicted as distinct steps in FIGS. 8A and 8B, step S801-S803 may not be distinct steps. In other embodiments, method 800 may not have all of the above steps and/or may have other steps in addition to or instead of those listed above. The steps of method 800 may be performed in another order. Subsets of the steps listed above as part of method 800 may be used to form their own method.

FIGS. 9A and 9B are flowcharts of an embodiment of a method 900 of operating retail terminal 940 or promotional offers terminal 920. Mobile terminal 910 may be any of the mobile terminals 110a, 110b, 210a, and 210b. Promotional offers terminal 920 may be any of the promotional offers terminals 120a, 120b, 220a, and 220b. Server 930 may be any of the servers 130a, 130b, 230a, and 230b. Retail terminal 940 may be any of the retail terminals 140, 240a, and 240b.

In step S901, after a consumer expresses an intention to use a promotional offer to a store assistant in a store, the store assistant may cause the promotional offers terminal 920 or the retail terminal 940 to send a code to the mobile terminal 910 of the consumer (retail terminal 940 may send the code directly to mobile terminal 910 or send a signal to promotional offers terminal 920, causing promotional terminal 920 to send the code). In sub-step S901a, the store assistant operates the promotional offers terminal 920 directly causing the promotional offers terminal to send the code. Optionally, in sub-step S901b, the store assistant operates on the retail terminal 940 to cause the retail terminal 940 to send a signal to the promotional offers terminal 920, which signal causes the promotional offers terminal 920 to send a code to the mobile terminal. In sub-step S901c, the promotional offers terminal 920 sends a code to the mobile terminal 910, which may be a public key for asymmetric encryption methods, which was discussed in conjunction with the encryption module 213a of FIG. 2A. In sub-step S901d, the mobile terminal 910 receives the code from promotional terminal 920 (or alternatively from retail terminal 940).

In step S902, the mobile terminal 910 encrypts the promotional offer information using the code sent by the promotional offers terminal 920 as an encryption key, and then sends the encrypted information to the promotional offers terminal 920. In sub-step S902a, the mobile terminal 910 encrypts the promotional offer information. In sub-step S902b, the mobile terminal 910 sends the encrypted information to the promotional offers terminal 920, while, in sub-step 902c, the promotional offers terminal 920 receives the encrypted information. Optionally, the server 930 receives the encrypted information from the promotional offers terminal 920 (sub-step S902d).

In step S903, after receiving the encrypted promotional offer information, the promotional offer information is decrypted according to predetermined encryption/decryption rules using a predetermined private key, or the same public key. Specifically, in sub-step S903a, the promotional offers terminal 920 decrypts the promotional offer information. In sub-step S903b, the server 930 decrypts the promotional offer information. The encryption and decryption at mobile terminal 220a or 220b may be performed by encryption modules 213a or 213b, respectively. The encryption and decryption methods were discussed in conjunction with the encryption module 213a of FIG. 2A and the encryption and decryption module 227 of FIG. 2C, which may be employed in sub-steps 903b and 903a, respectively.

In step S904, the promotional offers terminal 920 (sub-step S904a) or the server 930 (sub-step S904b) authenticates and/or identifies the decrypted promotional offer information. Step 904 may involve implementing steps S601b, S602 S603a, S604a and S605a of methods 600 and/or steps S703a, S704a, S705a, and S706a of method 700. Step S904a may be performed by first authentication module 121, 221a or 221b, and step S904b may be performed by second authentication module 131, 231a or 231b. The authentication and/or identification methods were discussed in conjunction with first authentication module 121 of FIG. 1A, method 600 of FIGS. 6A and 6B, and method 700 of FIGS. 7A and 7B, which may be used as part of sub-step 904a or sub-step 904b. Optionally, the results of the authentication and/or identification are sent to the mobile terminal 910, the promotional offers terminal 920, and/or the server 930.

In step S905, the promotional offers information and/or the authentication results are received by, and displayed on the screen or output systems of, the promotional offers terminal 920 (sub-step S905a), the retail terminal 940 (sub-step S905b), and/or the mobile terminal 910 (sub-step S905c).

In step S906, the store assistant, after viewing the authentication/identification information, causes the promotional offers terminal 920 and/or the retail terminal 940 to choose whether to use the promotional offer received from the mobile terminal 910, and then sends a user confirmation request to the mobile terminal 910. In sub-step S906a, the store assistant causes the promotional offers terminal 920 to directly send a user confirmation request to the mobile terminal 910. Optionally, in sub-step S906b, the store assistant causes the retail terminal 940 to send a signal to the promotional offers terminal, which signal causes the promotional offers terminal 920 to send a user confirmation request to mobile terminal 910. In sub-step S906c, the promotional offers terminal 920 sends a user confirmation request to the mobile terminal 910, asking the consumer to confirm whether he/she decides to redeem the promotional offer. In sub-step S906d, the mobile terminal 910 receives the user confirmation request. Optionally, the store assistant may choose which promotional offer or promotional offers to process if a plurality of promotional offer or promotional offers are received and authenticated/identified.

In step S907, the consumer confirms that the consumer desires to redeem the promotional offer using the mobile terminal 910, and the mobile terminal 910 sends the user confirmation back to the promotional offers terminal 920, while the promotional offer information is updated on the mobile terminal 910. In sub-step S907a, the mobile terminal 910 sends a user confirmation. In sub-step S907b, the promotional offers terminal 920 receives the user confirmation. In sub-step S907c, the mobile terminal 910 updates the promotional offer information in the promotional offer database stored on the mobile terminal 910. Optionally, the consumer could cancel the session via the mobile terminal 910 if he/she decides not to redeem the promotional offer.

In step S908, the promotional offers terminal 920 (sub-step S908a) and/or the retail terminal 940 (sub-step S908b) processes the promotional offer information. The processing of promotional offer information may be performed by promotion processing module 123, 223a, 223b or 245, which was discussed in conjunction with promotion processing module 123 of FIG. 1A and promotion processing module 245 of FIG. 2E.

In step S909, the promotional offers terminal 920 (sub-step S909a) the retail terminal 940 (sub-step S909b), and/or the server 930 (sub-step S909c) communicates with one another to update the promotional offer information. Optionally, the promotional offers terminal 920 in sub-step S909a, and/or the retail terminal 940 in sub-step S909b display the updated promotional offer information.

In an alternative embodiment, method 900 is performed at a self-checkout register, and the operations performed by the store assistant are performed automatically with no human involvement.

In an embodiment, each of the steps of method 900 is a distinct step. In at least one embodiment, although depicted as distinct steps in FIGS. 9A and 9B, step S901-S909 may not be distinct steps. In other embodiments, method 900 may not have all of the above steps and/or may have other steps in addition to or instead of those listed above. The steps of method 900 may be performed in another order. Subsets of the steps listed above as part of method 900 may be used to form their own method.

In a first example, one or more electronic cash vouchers are used via the promotion system including at least a mobile terminal, a promotional offers terminal, a server and a retail terminal, described in at least one embodiment. The steps may include:

1) A consumer decides to make a purchase and then proceeds to the retail terminal to make payment. The consumer uses the mobile terminal to send the cash voucher information to the promotional offers terminal. The cash voucher information may include the category of vouchers, the number of vouchers, the value of the vouchers, the rules or restrictions, for example. Optionally, the voucher information is encrypted by the mobile terminal before sending to the promotional offers terminal.

2) The promotional offers terminal receives and records the cash voucher information and decrypts and authenticates/identifies the cash voucher information. In at least one embodiment, the promotional offers terminal sends the cash voucher information to the server and decryption and authentication/identification can be performed by the server. After successfully decrypting and authenticating/identifying the information, the promotional offers terminal sends a request for user confirmation to the mobile terminal associated with the consumer. After the consumer uses the mobile terminal to confirm the cash voucher information to redeem, the mobile terminal sends the confirmation to the promotional offers terminal. The promotional offers terminal then processes the cash voucher and sends the cash voucher information to the retail terminal for redemption. The retail terminal calculates the value of the cash voucher and deducts the cash value from the balance of purchases made by the consumer. Then the retail terminal processes the payment.

3) After processing the cash voucher, the promotional offers terminal and/or the server updates the cash voucher information associated with the consumer's user account and/or the mobile terminal. Optionally, the number, category, and/or values of the redeemed cash vouchers and/or remaining vouchers or promotional offers are displayed on the screen of the promotional offers terminal. Optionally, the same information is displayed on the mobile terminal associated with the consumer.

In a second example, one or more gift promotional offers are used via the promotion system. The steps may include:

1) The consumer uses the mobile terminal to send the gift promotional offer information to the promotional offers terminal. The gift promotional offer information may include the category, the number, the rules/restriction for redeeming the gift promotional offers, the number, the choices of free items, for example.

2) The promotional offers terminal receives and records the gift promotional offer information, and the promotional offers terminal or the server decrypts and authenticates/identifies the information. The promotional offers terminal confirms with the mobile terminal to redeem the gift promotional offer, as discussed in conjunction with step 2) of the first exemplary embodiment. The promotional offers terminal then processes the gift promotional offer information and sends the information to the retail terminal for redemption. Optionally, the retail terminal records the gift promotional offer information and displays the gift promotional offer and/or gift options on a display of the retail terminal. For example, the gift promotional offer may include free items or free services. The store assistants or manager may distribute the free items/services according to the gift promotional offer information and the rules/restrictions. The retail terminal records the distribution of the free items/services in the inventory and marks the items/services as free.

3) After processing the one or more gift promotional offers, the promotional offers terminal and/or the server updates the promotional offer information associated with the consumer's user account and/or the mobile terminal. Optionally, the number and/or category of the redeemed gift promotional offers and/or remaining promotional offers or promotional offers are displayed on the screen of the promotional offers terminal. Optionally, the same information is displayed on the mobile terminal associated with the consumer.

FIG. 10 shows a block diagram of a computer 1000 used in at least one embodiment. The computer 1000 may include output system 1002, input system 1004, memory system 1006, processor system 1008, communications system 1012, and input/output system 1014. In other embodiments, computer 1000 may include additional components and/or may not include all of the components listed above.

Computer 1000 is an example of a computer that may be used for the retail terminal 140, 240a, 240b, 440, or 940, and/or the server 130a, 130b, 230a, 230b, 330, 430, 530, 630, 730, 830, or 930 in at least one embodiment.

Output system 1002 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example. In an embodiment of computer 1000 that is used as a retail terminal, output system 1002 may include a display for displaying consumption information, including prices of items purchased. Output system 1002 may also include an interface for communicating, via a network (e.g., the Internet) with the promotional offers terminal and/or the mobile terminal.

Input system 1004 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for example. In an embodiment of computer 1000 that is used as the retail terminal, input system 1004 may include special keys for inputting the prices and codes of items being purchased. In at least one embodiment of computer 1000 that is used as the retail terminal, input system 1004 may include operating the retail terminal as described in the steps 901 and/or 906 (FIG. 9A).

Memory system 1006 may include, for example, any one of, some of, any combination of, or all of a long term storage system, such as a hard drive; a short term storage system, such as random access memory; a removable storage system, such as a floppy drive or a removable drive; and/or flash memory. Memory system 1006 may include one or more machine-readable mediums that may store a variety of different types of information. The term machine-readable medium is used to refer to any non-transient medium capable carrying information that is readable by a machine. One example of a machine-readable medium is a non-transient computer-readable medium. Another example of a machine-readable medium is paper having holes that are detected that trigger different mechanical, electrical, and/or logic responses. In an embodiment of computer 1000 that is used as the retail terminal, memory system 1006 may include software for communicating with the promotional offers terminal, which may include machine instructions for transmitting consumption information to the promotional offers terminal and optionally for transmitting promotional offers to the mobile terminal. In an embodiment of computer 1000 that is used as the retail terminal, memory system 1006 may include software for processing purchases, processing promotional offer information, tracking inventory, tracking sales and transactions, issuing promotional offers, updating promotional offers data, updating sales and inventory information as transactions are performed, analyzing consumption information, and/or sending consumption data to the promotional offers terminal, the mobile terminal and/or the server. In an embodiment of computer 1000 that is used as the retail terminal, memory system 1006 may include communications module 241, third authentication module 242, promotion issuing module 243, purchase processing module 244, promotion processing module 245, fourth promotion database 246, sales database 247, sales analyzer 248, software for implementing steps 407, 408, 409 (FIG. 4B), and steps 901, 905, 906, 908 (FIGS. 9A and 9B). In an embodiment of computer 1000 that is used as the server, memory system 1006 may include second authentication module 131, 231a or 231b, data extraction module 232a or 232b, analysis module 233a or 233b, advertisement pushing module 234a or 234b, promotional offers terminal database 235a or 235b, second positioning module 236a or 236b, third promotion database 237, consumer database 238, retailer database 239.1, rules database 239.2, promotion manager 239.3, software for implementing steps 302 (FIGS. 3A and 3B), 403, 406, 409 (FIGS. 4A and 4B), 503 (FIGS. 5A and 5B), 603 (FIGS. 6A and 6B), 701, 703, 704 (FIGS. 7A and 7B), method 800 (FIGS. 8A and 8B), and steps 902, 903, 904, 909 (FIGS. 9A and 9B).

Processor system 1008 may include any one of, some of, any combination of, or all of multiple parallel processors, a single processor, a system of processors having one or more central processors and/or one or more specialized processors dedicated to specific tasks. In an embodiment of computer 1000 that is used as the retail terminal, processor system 1008 may implement machine instructions stored in memory system 1006, such as software for processing purchases, processing promotional offer information, tracking inventory, tracking sales and transactions, issuing promotional offers, updating promotional offers data, updating sales and inventory information as transactions are performed, analyzing consumption information, and/or sending consumption data to the promotional offers terminal, the mobile terminal and/or the server. In an embodiment of computer 1000 that is used as the retail terminal, processor system 1008 may implement the machine instruction stored in memory system 1006 such as communications module 241, third authentication module 242, promotion issuing module 243, purchase processing module 244, promotion processing module 245, fourth promotion database 246, sales database 247, sales analyzer 248, software for implementing steps 407, 408, 409 (FIG. 4B), and steps 901, 905, 906, 908 (FIGS. 9A and 9B). In an embodiment of computer 1000 that is used as the server, processor system 1008 may implement the machine instructions stored in memory system 1006, such as, second authentication module 131, 231a or 231b, data extraction module 232a or 232b, analysis module 233a or 233b, advertisement pushing module 234a or 234b, promotional offers terminal database 235a or 235b, second positioning module 236a or 236b, third promotion database 237, consumer database 238, retailer database 239.1, rules database 239.2, promotion manager 239.3, software for implementing steps 302 (FIGS. 3A and 3B), 403, 406, 409 (FIGS. 4A and 4B), 503 (FIGS. 5A and 5B), 603 (FIGS. 6A and 6B), 701, 703, 704 (FIGS. 7A and 7B), method 800 (FIGS. 8A and 8B), and steps 902, 903, 904, 909 (FIGS. 9A and 9B), if computer 1000 is used as the server.

Communications system 1012 communicatively links output system 1002, input system 1004, memory system 1006, processor system 1008, and/or input/output system to each other. Communications system 1012 may include any one of, some of, any combination of, or all of electrical cables, fiber optic cables, and/or means of sending signals through air or water (e.g. wireless communications), for example. Some examples of means of sending signals through air and/or water include systems for transmitting electromagnetic waves such as infrared and/or radio waves and/or systems for sending sound waves.

Input/output system 1014 may include devices that have the dual function as input and output devices. For example, input/output system 1014 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 1014 is optional, and may be used in addition to or in place of output system 1002 and/or input system 1004.

FIG. 11 shows a block diagram of an embodiment of the promotional offers terminal in at least one embodiment. The promotional offers terminal of FIG. 11 may be any of the promotional offers terminals 120a, 120b, 220a, 220b, 320, 420, 520, 620, 720, and 920. The promotional offers terminal may include output system 1102, input system 1104, memory system 1106, processor system 1108, communications system 1112, input/output system 1114, receiver 1116, transmitter 1118, microphone 1120, speaker 1122, signal generator 1124, and antenna 1126. In other embodiments, the promotional offers terminal may include additional components and/or may not include all of the components listed above.

Output system 1102, input system 1104, memory system 1106, processor system 1108, communications system 1112, input/output system 1114 were discussed in conjunction with output system 1002, input system 1004, memory system 1006, processor system 1008, communications system 1012, and input/output system 1014 of FIG. 10. However, memory system 1106 of the promotional offers terminal stores first authentication module 121, 221a or 221b, confirmation request module 122, 222a or 222b, promotion processing module 123, 223a or 223b, time record module 224a or 224b, first positioning module 225a or 225b, code transmission module 226a or 226b, encryption and decryption module 227, communications module 228, and second promotional offers database 229. Memory system 1106 of the promotional offers terminal also includes machine instructions for method 300 (FIGS. 3A and 3B), 400 (FIGS. 4A and 4B), 500 (FIGS. 5A and 5B), 600 (FIGS. 6A and 6B), 700 (FIGS. 7A and 7B), and 900 (FIGS. 9A and 9B). Processor system 1108 of the promotional offers terminal implements the machine instructions for method 300 (FIGS. 3A and 3B), 400 (FIGS. 4A and 4B), 500 (FIGS. 5A and 5B), 600 (FIGS. 6A and 6B), 700 (FIGS. 7A and 7B), and 900 (FIGS. 9A and 9B).

Receiver 1116 processes the signals received from retail terminal, mobile terminal, and/or server. Transmitter 1118 prepares signals for transmission and transmits signals to retail terminal, mobile terminal, and/or server. Microphone 1120 receives audio signals from mobile terminal. Speaker 1122 produces audio signals, which may be sent to mobile terminal. In an embodiment, speaker 1122 produces a near field signal. Signal generator 1124 produces signals, which may be converted into electromagnetic signals and/or audio signals. Antenna 1126 may send and receive electromagnetic signal. Antenna 1126 is an electromagnetic sensor.

FIG. 12 shows a block diagram of an embodiment of the mobile terminal in at least one embodiment. The mobile terminal of FIG. 12 may be any of the mobile terminals 110a, 110b, 210a, 210b, 310, 410, 510, 610, 710, 810, and 910. The mobile terminal may include output system 1202, input system 1204, memory system 1206, processor system 1208, communications system 1212, input/output system 1214, receiver 1216, transmitter 1218, microphone 1220, speaker 1222, signal generator 1224, antenna 1226, and an optional camera 1228. In other embodiments, the mobile terminal may include additional components and/or may not include all of the components listed above.

Output system 1202, input system 1204, memory system 1206, processor system 1208, communications system 1212, input/output system 1214 were discussed in conjunction with output system 1002, input system 1004, memory system 1006, processor system 1008, communications system 1012, and input/output system 1014 of FIG. 10.

However, memory system 1206 of the mobile terminal stores information transmission module 111, 211a, or 211b, confirmation module 112, 212a, or 212b, encryption module 213a or 213b, conversion module 214a or 214b, user account module 215, third positioning module 216, fourth authentication module 217, consumption analyzer module 218, social network application 219.1, search module 219.2 and first promotion database 219.3. Memory system 1206 of the mobile terminal also includes machine instructions for steps 301, 303, 304 (FIGS. 3A and 3B), 401, 402, 404, 405, 406, 409 (FIGS. 4A and 4B), 601 (FIGS. 6A and 6B), 702 (FIGS. 7A and 7B), 901, 902, 905, 906, 907 (FIGS. 9A and 9B), and method 500 (FIGS. 5A and 5B). Processor system 1208 of the mobile terminal implements the machine instructions of information transmission module 111, 211a, or 211b, confirmation module 112, 212a, or 212b, encryption module 213a or 213b, conversion module 214a or 214b, user account module 215, third positioning module 216, fourth authentication module 217, consumption analyzer module 218, social network application 219.1, search module 219.2 and first promotion database 219.3. Processor system 1208 of the mobile terminal implements the machine instructions for steps 301, 303, 304 (FIGS. 3A and 3B), 401, 402, 404, 405, 406, 409 (FIGS. 4A and 4B), 601 (FIGS. 6A and 6B), 702 (FIGS. 7A and 7B), 901, 902, 905, 906, 907 (FIGS. 9A and 9B), and method 500 (FIGS. 5A and 5B). In at least one embodiment, memory system 1206 of the mobile terminal may include a smart card chip capable of storing the instructions mentioned above, such as a SIM card or a Secure Memory Card.

Receiver 1216 processes the signals received from the promotional offers terminal, retail terminal, and/or server. Transmitter 1218 prepares signals for transmission to the promotional offers terminal, retail terminal, and/or server. Microphone 1220 receives audio signals from the promotional offers terminal (in addition to being used for carrying on a conversation during a phone call). Microphone 1220 may be a mini-microphone to be installed in a mobile device. Speaker 1222 produces audio signals, which may be sent to the promotional offers terminal (in addition to being used for carrying on a conversation during a phone call). Signal generator 1224 produces signals, which may be converted into electromagnetic signals and/or audio signals. Antenna 1226 may send and receive electromagnetic signal. Antenna 1226 may be an electromagnetic sensor. Optional camera 1228 is a camera that may come with the mobile terminal.

### Alternatives and Extensions

Each embodiment disclosed herein may be used or otherwise combined with any of the other embodiments disclosed. Any element of any embodiment may be used in any embodiment.

Promotion system in at least one embodiment may have other various embodiments, without departure from spirit and essence of the present specification, a person skilled in the art may make various corresponding modifications and variations according to the present specification. However, these modifications and variations should fall within the protective scope of the appended claims of the present specification.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A method, comprising:
receiving, at a promotional offers terminal from a mobile terminal, promotional offer information of at least one promotional offer associated with a consumer, the promotional offers terminal having a processor system including at least one processor, a memory system storing one or more machine instructions on one or more non-transitory computer readable media, and a network interface for communicating with at least the mobile terminal;
authenticating, by the promotional offers terminal, the promotional offer information;
sending, from the promotional offers terminal to the mobile terminal, a request for a confirmation for redeeming the at least one promotional offer;
receiving, at the promotional offers terminal from the mobile terminal, the confirmation; and
processing, by the promotional offers terminal, the promotional offer information.

2. The method of claim 1, wherein
the at least one promotional offer includes at least one of a promotional offering stamp, a discount promotional offer, a membership, a promotional offers promotion, a cash voucher, a purchase credit, a promotional offers point, mileage, a promotional offers incentive, and a gift token.

3. The method of claim 1, wherein
the promotional offer information includes at least
account information associated with the mobile terminal,
a promotional offer number for identifying each of the at least one promotional offer,
a validity start time, which is a time from when the at least one promotional offer begins to be valid,
an expiration time,
a time of issue,
a time associated with a transmission of the promotional information between the mobile terminal and the promotional offers terminal, and
a promotional offer code for denoting types of the at least one promotional offer.

4. The method of claim 1, wherein
the promotional offers terminal communicates with the mobile terminal when the mobile terminal is within 10 centimeters or less of the promotional offers terminal.

5. The method of claim 4, wherein
the promotional offers terminal communicates with the mobile terminal via audio signals.

6. The method of claim 1, further comprising
sending, from the promotional offers terminal to the mobile terminal, an encryption key; and
decrypting, by the promotional offers terminal using a decryption key, the promotional offer information being encrypted by the mobile terminal.

7. The method of claim 6, wherein
the encryption key is different from the decryption key.

8. The method of claim 6, wherein
the encryption key includes at least a terminal code of the promotional offers terminal and a random code, the random code being valid for a limited time.

9. The method of claim 1, further comprising
updating, at the promotional offers terminal, the promotional offer information, after the processing, by the promotional offers terminal, the promotional offer information.

10. The method of claim 1, the authenticating the promotional offer information further including at least
extracting, by the promotional offers terminal, a time of sending the promotional offer information from the mobile terminal;
recording, by the promotional offers terminal, a time of receipt of the promotional offer information;
calculating, by the promotional offers terminal, a time difference between the time of receipt of the promotional offer information and the time of sending the promotional offer information;
comparing, by the promotional offers terminal, the time difference and a predetermined time threshold; and
wherein the authentication is approved if the time difference is less than the predetermined time threshold, wherein the authentication is rejected if the time difference is more than or equal to the predetermined time threshold.

11. The method of claim 1, the authenticating the promotional offer information further including at least
extracting or obtaining, by the promotional offers terminal, installation location information of the promotional offers terminal;
obtaining, by the promotional offers terminal, present geographical position information of the mobile terminal when receiving the promotional offer information at the promotional offers terminal;
calculating, by the promotional offers terminal, a distance between the installation location information of the promotional offers terminal and the present geographical position information of the mobile terminal;
comparing, by the promotional offers terminal, the distance and a predetermined distance threshold; and
wherein the authentication is approved if the distance is less than the predetermined distance threshold, wherein the authentication is rejected if the distance is more than or equal to the predetermined distance threshold.

12. The method of claim 11, wherein
the present geographical position information of the mobile terminal includes at least a longitude, a latitude, and an altitude of the mobile terminal.

13. The method of claim 1, the authenticating the promotional offer information further including at least
sending the promotional offer information, from the promotional offers terminal to a server, for authentication by the server; and
receiving, at the promotional offers terminal from the server, results of the authentication including at least information about whether the authentication is approved or rejected.

14. The method of claim 1, the processing, by the promotional offers terminal, the promotional offer information further including at least
sending the promotional offer information, from the promotional offers terminal to a retail terminal for processing the promotional offer information by the retail terminal.

15. A method, comprising:
receiving, at a server from a promotional offers terminal, promotional offer information of at least one promotional offer associated with a consumer;
authenticating, by the server, the promotional offer information; and
sending, from the server to the promotional offers terminal, results of the authentication.

16. The method of claim 15, further comprising:
receiving, at the server from the promotional offers terminal, a decryption key; and
after the receiving promotional offer information, decrypting, by the server, the promotional offer information, wherein the promotional offer is encrypted by a mobile terminal.

17. The method of claim 15, further comprising:
updating, at the server, the promotional offer information, after the promotional offers terminal processing the promotional offer information.

18. The method of claim 15, further comprising:
sending, by the server to a mobile terminal, a request for personal data associated with a consumer, the personal data including at least social network data, consumption data, and promotional offer information associated with the consumer;
receiving, by the server from the mobile terminal, the personal data;
analyzing the personal data by the server; and
sending at least an advertisement to the mobile terminal.

19. The method of claim 18, further comprising:
generating a consumption statement based on the analysis of the personal data.

20. A method, comprising:
storing, at a mobile terminal, promotional offer information of at least one promotional offer associated with a consumer that is associated with the mobile terminal, the mobile terminal having a processor system including at least one processor, a memory system storing one or more machine instructions on one or more non-transitory computer readable media, and a network interface;
sending, from the mobile terminal to a promotional offers terminal, the promotional offer information, the promotional offers terminal being a terminal for communicating with one or more mobile terminals to at least transmit and process promotional offer information;
receiving, at the mobile terminal from the promotional offers terminal, a request for a confirmation for redeeming the at least one promotional offer;
sending, from the mobile terminal to the promotional offers terminal, the confirmation; and
updating, at the mobile terminal, the promotional offer information after the at least one promotional offer being redeemed.

21. The method of claim 20, further comprising:
converting, at the mobile terminal, at least one of a first type of promotional offer into at least one of a second type of promotional offer according to predetermined rules.

22. A promotional offers terminal, comprising:
a processor system having at least one processor,
a network interface,
a memory system storing one or more machine instructions on one or more non-transitory computer readable media; and
wherein the one or more machine instructions, when implemented, cause the processor system of the promotional offers terminal to implement a method including at least
receiving, at the promotional offers terminal from a mobile terminal, promotional offer information of at least one promotional offer associated with a consumer;
authenticating, by the promotional offers terminal, the promotional offer information;
sending, from the promotional offers terminal to the mobile terminal, a request for a confirmation for redeeming the at least one promotional offer;
receiving, at the promotional offers terminal from the mobile terminal, the confirmation; and
processing, by the promotional offers terminal, the promotional offer information.

23. The promotional offers terminal of claim 22, wherein
the at least one promotional offer includes at least one of a promotional offering stamp, a discount promotional offer, a membership, a promotional offers promotion, a cash voucher, a purchase credit, a promotional offers point, mileage, a promotional offers incentive, and a gift token.

24. The promotional offers terminal of claim 22, wherein
the promotional offer information includes at least
account information associated with the mobile terminal,
a promotional offer number for identifying each of the at least one promotional offer,
a validity start time, which is a time from when the at least one promotional offer begins to be valid,
an expiration time,
a time of issue,
a time associated with a transmission of the promotional information between the mobile terminal and the promotional offers terminal, and
a promotional offer code for denoting types of the at least one promotional offer.

25. The promotional offers terminal of claim 22, wherein
the network interface allows the promotional offers terminal to communicate with the mobile terminal via audio signals.

26. The promotional offers terminal of claim 22, further comprising
at least a signal generator for converting data into audio signals;
at least a signal transmitter for transmitting the audio signals; and
at least a receiver for receiving the audio signals.

27. The promotional offers terminal of claim 22, further comprising
a protective shell for preventing unauthorized terminals to receive signals from the promotional offers terminal.

28. The promotional offers terminal of claim 22, the method implemented by the one or more machine instructions further including
sending, from the promotional offers terminal to the mobile terminal, an encryption key; and
decrypting, by the promotional offers terminal using a decryption key, the promotional offer information being encrypted by the mobile terminal.

29. The promotional offers terminal of claim 28, wherein
the encryption key is different from the decryption key.

30. The promotional offers terminal of claim 29, wherein
the encryption key includes at least a terminal code of the promotional offers terminal and a random code, the random code being valid for a limited time.

31. The promotional offers terminal of claim 22, the method implemented by the one or more machine instructions further including
updating, at the promotional offers terminal, the promotional offer information, after the processing, by the promotional offers terminal, the promotional offer information.

32. The promotional offers terminal of claim 22, wherein the authenticating the promotional offer information further includes at least
extracting, by the promotional offers terminal, a time of sending the promotional offer information from the mobile terminal;
recording, by the promotional offers terminal, a time of receipt of the promotional offer information at the promotional offers terminal;
calculating, by the promotional offers terminal, a time difference between the time of receipt of the promotional offer information and the time of sending the promotional offer information;
comparing, by the promotional offers terminal, the time difference and a predetermined time threshold; and
wherein the authentication is approved if the time difference is less than the predetermined time threshold, wherein the authentication is rejected if the time difference is more than or equal to the predetermined time threshold.

33. The promotional offers terminal of claim 22, wherein the authenticating the promotional offer information further includes at least
extracting or obtaining, by the promotional offers terminal, installation location information of the promotional offers terminal;
obtaining, by the promotional offers terminal, present geographical position information of the mobile terminal when receiving the promotional offer information at the at least a promotional offers terminal;
calculating, by the promotional offers terminal, a distance between the installation location information of the promotional offers terminal and the present geographical position information of the mobile terminal;
comparing, by the promotional offers terminal, the distance and a predetermined distance threshold; and
wherein the authentication is approved if the distance is less than the predetermined distance threshold, wherein the authentication is rejected if the distance is more than or equal to the predetermined distance threshold.

34. The promotional offers terminal of claim 22, wherein the authenticating the promotional offer information further includes at least sending the promotional offer information, from the promotional offers terminal to a server, for authentication by the server; and
receiving, at the promotional offers terminal from the server, results of the authentication including at least information about whether the authentication is approved or rejected.

35. The promotional offers terminal of claim 22, wherein the processing, by the promotional offers terminal, the promotional offer information further includes at least
sending the promotional offer information, from the promotional offers terminal to a retail terminal for processing the promotional offer information by the retail terminal.

36. A server, comprising:
a processing system having at least a processor, a network interface, a memory system storing one or more machine instructions on one or more non-transitory computer readable media; and
wherein the one or more machine instructions, when implemented, cause the processor system of the server to implement a method including at least:
receiving, at the server from a promotional offers terminal, promotional offer information of at least one promotional offer associated with a consumer;
authenticating, by the server, the promotional offer information; and
sending, from the server to the promotional offers terminal, results of the authentication including at least information about whether the authentication is approved or rejected.

37. The server of claim 36, the method implemented by the one or more machine instructions further including
receiving, at the server from the promotional offers terminal, a decryption key; and
after the receiving promotional offer information, decrypting, by the server, the promotional offer information, wherein the promotional offer is encrypted by a mobile terminal.

38. The server of claim 36, the method implemented by the one or more machine instructions further including
updating, at the server, the promotional offer information, after the promotional offers terminal processing the promotional offer information.

39. A server, comprising:
a processor system having at least a processor, a network interface, a memory system storing one or more machine instructions on one or more non-transitory computer readable media; and
wherein the one or more machine instructions, when implemented, cause the processor system of the server to implement a method including at least:
extracting, by the server from a mobile terminal, personal data associated with a consumer, the personal data including at least social network data, consumption data, and promotional offer information associated with the consumer; and
analyzing the personal data by the server.

40. The server of claim 39, the method implemented by the one or more machine instructions further including
generating a consumption statement based on the analysis of the personal data.

41. The server of claim 39, the method implemented by the one or more machine instructions further including
sending at least an advertisement or a promotional offer to the mobile terminal.

42. A mobile terminal, comprising:
a processor system having at least a processor, a network interface, a memory system storing one or more machine instructions on one or more non-transitory computer readable media; and
wherein the one or more machine instructions, when implemented, cause the processor system of the mobile terminal to implement a method including at least
storing, at the mobile terminal, promotional offer information of at least one promotional offer associated with a consumer;
sending, from the mobile terminal to a promotional offers terminal, the promotional offer information, the promotional offers terminal being a terminal for communicating with one or more mobile terminals to at least transmit and process promotional offer information;
receiving, at the mobile terminal from the promotional offers terminal, a request for a confirmation for redeeming the at least one promotional offer;
sending, from the mobile terminal to the promotional offers terminal, the confirmation; and
updating, at the mobile terminal, the promotional offer information after the at least one promotional offer being redeemed.

43. The mobile terminal of claim 42, the method implemented by the one or more machine instructions further including
receiving at least an advertisement or promotional offer information from a server.

44. The mobile terminal of claim 42, wherein
the network interface allows the mobile terminal to communicate with the promotional offers terminal via audio signals.

45. The mobile terminal of claim 42, further comprising
at least a signal generator for converting data into audio signals;
at least a signal transmitter for transmitting the audio signals; and
at least a receiver for receiving the audio signals.

46. The mobile terminal of claim 42, the method implemented by the one or more machine instructions further including
receiving, at the mobile terminal from the promotional offers terminal or a server, an encryption key; and
encrypting, by the mobile terminal, the coupon information.

47. The mobile terminal of claim 42, the method implemented by the one or more machine instructions further including
converting at least one of a first type of promotional offer into at least one of a second type of promotional offer; and
updating the first type of promotional offer and the second type of promotional offer.
